(19) United States
(12) Patent Application Publication
(10) Pub. No.: US 2026/0295557 A1
(43) Pub. Date: Oct. 1, 2026

(54) SORBENT MATERIALS FOR GAS STORAGE

(71) Applicant: Entegris, Inc., Billerica, MA (US)

(72) Inventors: Alemayehu Hailu Bedane, Watertown, CT (US); Kaitlin J. Lawrence, Brookfield, CT (US); Joseph R. Despres, Middletown, CT (US)

(21) Appl. No.: 19/570,955

(22) Filed: Mar. 18, 2026

Related U.S. Application Data
(60) Provisional application No. 63/780,142, filed on Mar. 28, 2025.
(60) Provisional application No. 63/894,579, filed on Oct. 6, 2025.

(51) Int. Cl. B01J 20/20; B01J 20/28; B01J 20/30; B01J 20/34; C01B 32/318; C01B 32/336; F17C 11/00

(52) U.S. Cl. CPC B01J 20/20; B01J 20/28011; B01J 20/28042; B01J 20/28066; B01J 20/28088; B01J 20/3078; B01J 20/3416; B01J 20/3483; B01J 20/3491; C01B 32/318; C01B 32/336; F17C 11/00; C01P 2006/12; C01P 2006/17

(57) ABSTRACT

A method of forming a sorbent material comprises obtaining a pyrolyzable component comprising polyether ether ketone (PEEK), polyether ketone ketone (PEKK), polyphenylene oxide (PPO), or a combination thereof; oxidizing the pyrolyzable component; pyrolyzing the pyrolyzable component to form a monolithic pyrolyzed carbon component; and activating the monolithic pyrolyzed carbon component. At a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity. Sorbent materials, gas storage vessels, and related assemblies are also provided.

### CROSS-REFERENCE TO RELATED APPLICATIONS

This application claims the benefit of U.S. Provisional Application No. 63/894,579, filed Oct. 6, 2025, which claims the benefit of U.S. Provisional Application No. 63/780,142, filed Mar. 28, 2025, the disclosures of which are incorporated herein by reference in their entireties.

### FIELD

The present disclosure relates to storage materials for gas storage, related assemblies, and related methods.

### BACKGROUND

Gas storage vessels are used in a variety of industrial applications, including semiconductor manufacturing, where precise delivery of specialty gases such as arsine and phosphine is required. These gases are often stored at sub-atmospheric pressures using sorbent materials contained within the gas storage vessel. The sorbent materials sorb the gas during storage and desorb the gas during delivery to downstream process tools.

Conventional sorbent materials for sub-atmospheric gas storage include activated carbon materials derived from various polymeric precursors. The performance characteristics of these sorbent materials—including gas sorption capacity, gas deliverable capacity, and the ratio of deliverable capacity to sorption capacity—are influenced by the material's physical properties, such as surface area, pore size distribution, and density

### SUMMARY

Some embodiments relate to a method. In some embodiments, the method comprises obtaining a pyrolyzable component. In some embodiments, the pyrolyzable component comprises at least one of a polyether ether ketone (PEEK), a polyether ketone ketone (PEKK), a polyphenylene oxide (PPO), or any combination thereof. In some embodiments, the method comprises oxidizing the pyrolyzable component. In some embodiments, the method comprises pyrolyzing the pyrolyzable component to form a pyrolyzed carbon component. In some embodiments, the method comprises activating the pyrolyzed carbon component to obtain an activated pyrolyzed carbon component. In some embodiments, when contained in a gas storage vessel, the activated pyrolyzed carbon component is configured to sorb and desorb a gas. In some embodiments, at a temperature of 21° C. and a pressure of 650 Torr or less, the activated pyrolyzed carbon component is configured to desorb at least 60% of a sorbed gas, as determined by a ratio of a gas deliverable capacity to a gas sorption capacity.

Some embodiments relate to an assembly. In some embodiments, the assembly comprises a gas storage vessel. In some embodiments, the gas storage vessel comprises a sorbent material. In some embodiments, the sorbent material is contained in an interior volume of the gas storage vessel. In some embodiments, the sorbent material comprises an activated pyrolyzed carbon component. In some embodiments, at a temperature of 21° C. and a pressure of 650 Torr or less, the activated pyrolyzed carbon component is configured to desorb at least 60% of a sorbed gas, as determined by a ratio of a gas deliverable capacity and a gas sorption capacity.

Some embodiments relate to a sorbent material. In some embodiments, the sorbent material comprises an activated pyrolyzed carbon component. In some embodiments, when contained in a gas storage vessel, the activated carbon component is configured to sorb and desorb a gas. In some embodiments, at a temperature of 21° C. and a pressure of 650 Torr or less, the activated pyrolyzed carbon component is configured to desorb at least 60% of a sorbed gas, as determined by a ratio of a gas deliverable capacity to a gas sorption capacity.

Some embodiments relate to a method. In some embodiments, the method comprises adjusting at least one of a pressure, a temperature, or any combination thereof, of a gas storage vessel. In some embodiments, the gas storage vessel comprises an activated pyrolyzed carbon component. In some embodiments, the gas storage vessel comprises at least one sorbed gas on the activated pyrolyzed carbon component. In some embodiments, the method comprises desorbing at least 60% of the at least one sorbed gas from the activated pyrolyzed carbon component.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### DRAWINGS

The disclosure may be more completely understood in consideration of the following description of various illustrative embodiments in connection with the accompanying drawings, in which:

FIG. 1 is a flowchart of a method for delivering a gas, according to some embodiments;

FIG. 2 is a flowchart of a method for producing an activated pyrolyzed carbon component, according to some embodiments;

FIG. 3 shows arsine sorption isotherms, according to some embodiments;

FIG. 4 shows phosphine sorption isotherms, according to some embodiments;

FIG. 5 shows the amount of arsine gas delivered over a pressure range, according to some embodiments;

FIG. 6 shows the amount of arsine gas delivered over a pressure range, according to some embodiments;

FIG. 7 shows the amount of phosphine gas delivered over a pressure range, according to some embodiments;

FIG. 8 shows the amount of phosphine gas delivered over a pressure range, according to some embodiments;

FIG. 9 shows the BET volumetric surface area and arsine deliverable capacity for each sample, according to some embodiments;

FIG. 10 shows the BET volumetric surface area and phosphine deliverable capacity for each sample, according to some embodiments;

FIG. 11 shows the volumetric deliverable capacity of arsine over various pressure ranges, according to some embodiments;

FIG. 12 shows arsine sorption isotherms, according to some embodiments;

FIG. 13 shows the amount of arsine gas delivered over a pressure range, according to some embodiments;

FIG. 14 shows phosphine sorption isotherms, according to some embodiments;

FIG. 15 shows the amount of phosphine gas delivered over a pressure range, according to some embodiments;

FIG. 16 shows nitrogen sorption isotherms, according to some embodiments;

FIG. 17 shows BET volumetric surface area, according to some embodiments; and

FIG. 18 shows the arsine deliverable amount versus the BET volumetric surface area, according to some embodiments.

It should be understood that the drawings are provided solely for purposes of illustrating various aspects of the disclosed methods and data analyses. The flow charts, isotherms, graphical relationships, and other representations shown in the figures are not intended to be limiting, nor are they necessarily drawn to scale. Variations in sequence, arrangement, presentation, or the form of the illustrated data may be made without departing from the spirit and scope of the invention as defined by the claims.

### DETAILED DESCRIPTION

As used in this specification and the appended claims, the singular forms “a,” “an,” and “the” include plural referents unless the content clearly dictates otherwise. As used in this specification and the appended claims, the term “or” is generally employed in its sense including “and/or” unless the content clearly dictates otherwise.

Some embodiments relate to a sorbent material. In some embodiments, the sorbent material is utilized in gas storage devices. In some embodiments, the gas storage devices store and deliver gases at sub-atmospheric pressures. In some embodiments, the sorbent material has improved gas sorption capacity and gas deliverable capacity over conventional gas storage sorbent materials. As used herein, a “gas sorption capacity” refers to the amount of gas the sorbent material can sorb at a temperature of 21° C. and a pressure of 650 Torr or greater. As used herein, a “gas deliverable capacity” refers to the amount of sorbed gas the sorbent material can desorb at a temperature of 21° C. and a pressure of 650 Torr or less. In some embodiments, the sorbent material has a higher Brunauer-Emmett-Teller (BET) volumetric surface area and an improved pore size distribution as compared to conventional gas storage sorbent materials. BET is a standard method for measuring surface area of porous solid materials using gas adsorption. The BET volumetric surface area can be measured using ISO 9277. The higher BET volumetric surface area, among other things, contributes to the improved gas sorption capacity and the improved pore size distribution, among other things, contributes to the improved gas deliverable capacity.

In some embodiments, the sorbent material comprises a material that is configured to sorb a gas. In some embodiments, the sorbent material comprises a material that is configured to at least one of adsorb, absorb, or any combination thereof, a gas. In some embodiments, the sorbent material is configured to desorb the sorbed gas.

In some embodiments, the sorbent material comprises a carbon component. In some embodiments, the carbon component comprises a pyrolyzed carbon component. In some embodiments, the pyrolyzed carbon component comprises an activated pyrolyzed carbon component.

In some embodiments, the activated pyrolyzed carbon component comprises at least one polymer. In some embodiments, the at least one polymer comprises at least one of a homopolymer, a copolymer, or any combination thereof. In some embodiments, the at least one polymer comprises at least one of a polyvinylidene chloride (PVDC), a polyvinylidene fluoride (PVDF), a polytetrafluoroethylene (PTFE), a poly (ethene-co-tetrafluoroethene), or any combination thereof.

In some embodiments, the activated pyrolyzed carbon component has a density of 0.5 g/cm³ to 2.5 g/cm³, or any range or subrange between 0.5 g/cm³ to 2.5 g/cm³. For example, in some embodiments, the activated pyrolyzed carbon component has a density of 0.5 g/cm³ to 2.4 g/cm³, 0.5 g/cm³ to 2.3 g/cm³, 0.5 g/cm³ to 2.2 g/cm³, 0.5 g/cm³ to 2.1 g/cm³, 0.5 g/cm³ to 2, 0.5 g/cm³ to 1.9 g/cm³, 0.5 g/cm³ to 1.8 g/cm³, 0.5 g/cm³ to 1.7 g/cm³, 0.5 g/cm³ to 1.6 g/cm³, 0.5 g/cm³ to 1.5 g/cm³, 0.5 g/cm³ to 1.4 g/cm³, g/cm³ to 1.3 g/cm³, 0.5 g/cm³ to 1.2 g/cm³, 0.5 g/cm³ to 1.1 g/cm³, 0.5 g/cm³ to 1.0 g/cm³, 0.5 g/cm³ to 0.9 g/cm³, 0.5 g/cm³ to 0.8 g/cm³, 0.5 g/cm³ to 0.7 g/cm³, 0.5 g/cm³ to 0.6 g/cm³, 0.6 g/cm³ to 2.5 g/cm³, 0.7 g/cm³ to 2.5 g/cm³, 0.8 g/cm³ to 2.5 g/cm³, 0.9 g/cm³ to 2.5 g/cm³, 1.0 g/cm³ to 2.5 g/cm³, 1.1 g/cm³ to 2.5 g/cm³, 1.2 g/cm³ to 2.5 g/cm³, 1.3 g/cm³ to 2.5 g/cm³, 1.4 g/cm³ to 2.5 g/cm³, 1.5 g/cm³ to 2.5 g/cm³, 1.6 g/cm³ to 2.5 g/cm³, 1.7 g/cm³ to 2.5 g/cm³, 1.8 g/cm³ to 2.5 g/cm³, 1.9 g/cm³ to 2.5 g/cm³, 2 g/cm³ to 2.5 g/cm³, 2.1 g/cm³ to 2.5 g/cm³, 2.2 g/cm³ to 2.5 g/cm³, 2.3 g/cm³ to 2.5 g/cm³, or 2.4 g/cm³ to 2.5 g/cm³.

In some embodiments, the activated pyrolyzed carbon component has a density of 0.5 g/cm³ to 1.2 g/cm³, or any range or subrange between 0.5 g/cm³ to 1.2 g/cm³. For example, in some embodiments, the activated pyrolyzed carbon component has a density of 0.5 g/cm³ to 1.1 g/cm³, 0.5 g/cm³ to 1.0 g/cm³, 0.5 g/cm³ to 0.9 g/cm³, 0.5 g/cm³ to 0.8 g/cm³, 0.5 g/cm³ to 0.7 g/cm³, 0.5 g/cm³ to 0.6 g/cm³, 0.6 g/cm³ to 1.2 g/cm³, 0.7 g/cm³ to 1.2 g/cm³, 0.8 g/cm³ to 1.2 g/cm³, 0.9 g/cm³ to 1.2 g/cm³, 1.0 g/cm³ to 1.2 g/cm³, or 1.1 g/cm³ to 1.2 g/cm³.

In some embodiments, the activated pyrolyzed carbon component has a density of 0.75 g/cm³ to 2.5 g/cm³, or any range or subrange between 0.75 g/cm³ to 2.5 g/cm³. For example, in some embodiments, the activated pyrolyzed carbon component has a density of 0.75 g/cm³ to 2.4 g/cm³, 0.75 g/cm³ to 2.3 g/cm³, 0.75 g/cm³ to 2.2 g/cm³, 0.75 g/cm³ to 2.1 g/cm³, 0.75 g/cm³ to 2, 0.75 g/cm³ to 1.9 g/cm³, 0.75 g/cm³ to 1.8 g/cm³, 0.75 g/cm³ to 1.7 g/cm³, 0.75 g/cm³ to 1.6 g/cm³, 0.75 g/cm³ to 1.5 g/cm³, 0.75 g/cm³ to 1.4 g/cm³, g/cm³ to 1.3 g/cm³, 0.75 g/cm³ to 1.2 g/cm³, 0.75 g/cm³ to 1.1 g/cm³, 0.75 g/cm³ to 1.0 g/cm³, 0.75 g/cm³ to 0.9 g/cm³, 0.75 g/cm³ to 0.8 g/cm³, 0.8 g/cm³ to 2.5 g/cm³, 0.9 g/cm³ to 2.5 g/cm³, 1.0 g/cm³ to 2.5 g/cm³, 1.1 g/cm³ to 2.5 g/cm³, 1.2 g/cm³ to 2.5 g/cm³, 1.3 g/cm³ to 2.5 g/cm³, 1.4 g/cm³ to 2.5 g/cm³, 1.5 g/cm³ to 2.5 g/cm³, 1.6 g/cm³ to 2.5 g/cm³, 1.7 g/cm³ to 2.5 g/cm³, 1.8 g/cm³ to 2.5 g/cm³, 1.9 g/cm³ to 2.5 g/cm³, 2 g/cm³ to 2.5 g/cm³, 2.1 g/cm³ to 2.5 g/cm³, 2.2 g/cm³ to 2.5 g/cm³, 2.3 g/cm³ to 2.5 g/cm³, or 2.4 g/cm³ to 2.5 g/cm³.

In some embodiments, the activated pyrolyzed carbon component has a Brunauer-Emmett-Teller (BET) volumetric surface area of 1200 m²/cc or greater. For example, in some embodiment, the activated pyrolyzed carbon component has a BET volumetric surface area of 1250 m²/cc or greater, 1300 m²/cc or greater, 1350 m²/cc or greater, 1400 m²/cc or greater, 1450 m²/cc or greater, 1500 m²/cc or greater, 1550 m²/cc or greater, 1600 m²/cc or greater, 1650 m²/cc or greater, 1700 m²/cc or greater, 1750 m²/cc or greater, or 1800 m²/cc or greater.

In some embodiments, the activated pyrolyzed carbon component has a BET volumetric surface area of 800 m²/cc to 1600 m²/cc, or any range or subrange between 800 m²/cc to 1600 m²/cc. In other embodiments, the activated pyrolyzed carbon component has a BET volumetric surface area of 1200 m²/cc to 1600 m²/cc. For example, in some embodiments, the activated pyrolyzed carbon component has a BET volumetric surface area of 800 m²/cc to 1550 m²/cc, 800 m²/cc to 1500 m²/cc, 800 m²/cc to 1450 m²/cc, 800 m²/cc to 1400 m²/cc, 800 m²/cc to 1350 m²/cc, 800 m²/cc to 1300 m²/cc, 800 m²/cc to 1250 m²/cc, 800 m²/cc to 1200 m²/cc, 800 m²/cc to 1150 m²/cc, 800 m²/cc to 1100 m²/cc, 800 m²/cc to 1050 m²/cc, 800 m²/cc to 1000 m²/cc, 800 m²/cc to 950 m²/cc, 800 m²/cc to 900 m²/cc, 800 m²/cc to 850 m²/cc, 850 m²/cc to 1600 m²/cc, 900 m²/cc to 1600 m²/cc, 950 m²/cc to 1600 m²/cc, 1000 m²/cc to 1600 m²/cc, 1050 m²/cc to 1600 m²/cc, 1100 m²/cc to 1600 m²/cc, 1150 m²/cc to 1600 m²/cc, 1200 m²/cc to 1600 m²/cc, 1250 m²/cc to 1600 m²/cc, 1300 m²/cc to 1600 m²/cc, 1350 m²/cc to 1600 m²/cc, 1400 m²/cc to 1600 m²/cc, 1450 m²/cc to 1600 m²/cc, 1500 m²/cc to 1600 m²/cc, or 1550 m²/cc to 1600 m²/cc.

In some embodiments, the activated pyrolyzed carbon component comprises a porous activated pyrolyzed carbon component. In some embodiments, the activated pyrolyzed carbon component has a porosity of at least 40%. For example, in some embodiments, the activated pyrolyzed carbon component has a porosity of at least 45%, at least 50%, at least 55%, at least 60%, at least 65%, at least 70%, at least 75%, at least 80%, at least 85%, or at least 90%. In some embodiments, the activated pyrolyzed carbon component has a porosity of 40% to 90%, or any range or subrange between 40% to 90%. For example, in some embodiments, the activated pyrolyzed carbon component has a porosity of 40% to 85%, 40% to 80%, 40% to 75%, 40% to 70%, 40% to 65%, 40% to 60%, 40% to 55%, 40% to 50%, 40% to 45%, 45% to 90%, 50% to 90%, 55% to 90%, 60% to 90%, 65% to 90%, 70% to 90%, 75% to 90%, 80% to 90%, or 85% to 90%.

In some embodiments, the activated pyrolyzed carbon component has a pore size distribution of 0.7 nm to 2.5 nm, or any range or subrange between 0.7 nm to 2.5 nm. For example, in some embodiments, the activated pyrolyzed carbon component has a pore size distribution of 0.7 nm to 2.4 nm, 0.7 nm to 2.3 nm, 0.7 nm to 2.2 nm, 0.7 nm to 2.1 nm, 0.7 nm to 2.0 nm, 0.7 nm to 1.9 nm, 0.7 nm to 1.8 nm, 0.7 nm to 1.7 nm, 0.7 nm to 1.6 nm, 0.7 nm to 1.5 nm, 0.7 nm to 1.4 nm, 0.7 nm to 1.3 nm, 0.7 nm to 1.2 nm, 0.7 nm to 1.1 nm, 0.7 nm to 1 nm, 0.7 nm to 0.9 nm, 0.7 nm to 0.8 nm, 0.8 nm to 2.5 nm, 0.9 nm to 2.5 nm, 1 nm to 2.5 nm, 1.1 nm to 2.5 nm, 1.2 nm to 2.5 nm, 1.3 nm to 2.5 nm, 1.4 nm to 2.5 nm, 1.5 nm to 2.5 nm, 1.6 nm to 2.5 nm, 1.7 nm to 2.5 nm, 1.8 nm to 2.5 nm, 1.9 nm to 2.5 nm, 2.0 nm to 2.5 nm, 2.1 nm to 2.5 nm, 2.2 nm to 2.5 nm, 2.3 nm to 2.5 nm, or 2.4 nm to 2.5 nm. In some embodiments, an ASAP 2024 micromeritics instrument is utilized to run N₂ adsorption at 77 K to measure surface area and pore size distribution. In some embodiments, the pore size distribution is a density functional theory (DFT) pore size distribution. In some embodiments, the DFT methodology used to determine the pore size distribution include at least one of Dubinin-Astakhov (D-A), Dubinin-Radushkevich (D-R), Horvath-Kawazoe (H-K), or any combination thereof.

In some embodiments, the activated pyrolyzed carbon component comprises a monolithic activated pyrolyzed carbon component. As used herein, the term “monolithic” refers to a single unitary piece. In some embodiments, the monolithic activated pyrolyzed carbon component is in the form of at least one of a puck, a brick, a cylinder, a block, or any combination thereof. In some embodiments, the monolithic activated pyrolyzed carbon component is not present in the form of a plurality of particles. In some embodiments, the monolithic activated pyrolyzed carbon component is free of cracks.

In some embodiments, the monolithic activated pyrolyzed carbon component has at least one dimension in a range of 1 mm to 200 mm, or any range or subrange between 1 mm to 200 mm. For example, in some embodiments, the monolithic activated pyrolyzed carbon component has at least one dimension in a range of 1 mm to 190 mm, 1 mm to 180 mm, 1 mm to 170 mm, 1 mm to 160 mm, 1 mm to 150 mm, 1 mm to 140 mm, 1 mm to 130 mm, 1 mm to 120 mm, 1 mm to 110 mm, 1 mm to 100 mm, 1 mm to 90 mm, 1 mm to 80 mm, 1 mm to 70 mm, 1 mm to 60 mm, 1 mm to 50 mm, 1 mm to 40 mm, 1 mm to 30 mm, 1 mm to 20 mm, 1 mm to 10 mm, 10 mm to 200 mm, 20 mm to 200 mm, 30 mm to 200 mm, 40 mm to 200 mm, 50 mm to 200 mm, 60 mm to 200 mm, 70 mm to 200 mm, 80 mm to 200 mm, 90 mm to 200 mm, 100 mm to 200 mm, 110 mm to 200 mm, 120 mm to 200 mm, 130 mm to 200 mm, 140 mm to 200 mm, 150 mm to 200 mm, 160 mm to 200 mm, 170 mm to 200 mm, 180 mm to 200 mm, or 190 mm to 200 mm.

In some embodiments, the at least one dimension comprises at least one of a length, a width, a diameter, a thickness, or any combination thereof. In some embodiments, the at least one dimension comprises a diameter and a thickness. In some embodiments, the at least one dimension comprises at least one dimension of a cylindrical shape.

In some embodiments, at a temperature of 21° C. and a pressure of 650 Torr or less, the activated pyrolyzed carbon component is configured to desorb at least 60% of a sorbed gas, as determined by a ratio of a gas deliverable capacity to a gas sorption capacity. For example, in some embodiments, at a temperature of 21° C. and a pressure of 650 Torr or less, the activated pyrolyzed carbon component is configured to desorb at least 65%, at least 70%, at least 75%, at least 80%, at least 85%, at least 90%, at least 95%, or at least 99% of a sorbed gas, as determined by a ratio of a gas deliverable capacity to a gas sorption capacity.

In some embodiments, at a temperature of 21° C. and a pressure of 650 Torr or less, the activated pyrolyzed carbon component is configured to desorb 60% to 100% of a sorbed gas, as determined by a ratio of a gas deliverable capacity to a gas sorption capacity. For example, in some embodiments, at a temperature of 21° C. and a pressure of 650 Torr or less, the activated pyrolyzed carbon component is configured to desorb 60% to 99%, 60% to 95%, 60% to 90%, 60% to 85%, 60% to 80%, 60% to 75%, 60% to 70%, 60% to 65%, 65% to 100%, 70% to 100%, 75% to 100%, 80% to 100%, 85% to 100%, 90% to 100%, 95% to 100%, or 99% to 100% of a sorbed gas, as determined by a ratio of a gas deliverable capacity to a gas sorption capacity.

In some embodiments, the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydrides, a halide compound, an organometallic compound, or any combination thereof.

In some embodiments, at a temperature of 21° C. and a pressure of 650 Torr or less, the activated pyrolyzed carbon component is configured to have a gas deliverable capacity of 150 g/L to 650 g/L, or any range or subrange between 150 g/L to 650 g/L. For example, at a temperature of 21° C. and a pressure of 650 Torr or less, the activated pyrolyzed carbon component is configured to have a gas deliverable capacity of 150 g/L to 625 g/L, 150 g/L to 600 g/L, 150 g/L to 575 g/L, 150 g/L to 550 g/L, 150 g/L to 525 g/L, 150 g/L to 500 g/L, 150 g/L to 475 g/L, 150 g/L to 450 g/L, 150 g/L to 425 g/L, 150 g/L to 400 g/L, 150 g/L to 375 g/L, 150 g/L to 350 g/L, 150 g/L to 325 g/L, 150 g/L to 300 g/L, 150 g/L to 275 g/L, 150 g/L to 250 g/L, 150 g/L to 225 g/L, 150 g/L to 200 g/L, 150 g/L to 175 g/L, 175 g/L to 650 g/L, 200 g/L to 650 g/L, 225 g/L to 650 g/L, 250 g/L to 650 g/L, 275 g/L to 650 g/L, 300 g/L to 650 g/L, 325 g/L to 650 g/L, 350 g/L to 650 g/L, 375 g/L to 650 g/L, 400 g/L to 650 g/L, 425 g/L to 650 g/L, 450 g/L to 650 g/L, 475 g/L to 650 g/L, 500 g/L to 650 g/L, 525 g/L to 650 g/L, 550 g/L to 650 g/L, 575 g/L to 650 g/L, 600 g/L to 650 g/L, or 625 g/L to 650 g/L.

In some embodiments, the gas deliverable capacity is dependent on the gas. For example, in some embodiments, when the gas is arsine, at a temperature of 21° C. and a pressure of 650 Torr or less, the activated pyrolyzed carbon component is configured to have an arsine deliverable capacity of 300 g/L to 600 g/L, or any range or subrange between 300 g/L to 600 g/L. In some embodiments, when the gas is arsine, at a temperature of 21° C. and a pressure of 650 Torr or less, the activated pyrolyzed carbon component is configured to have an arsine deliverable capacity of 300 g/L to 575 g/L, 300 g/L to 550 g/L 300 g/L to 525 g/L, 300 g/L to 500 g/L, 300 g/L to 475 g/L, 300 g/L to 450 g/L, 300 g/L to 425 g/L, 300 g/L to 400 g/L, 300 g/L to 375 g/L, 300 g/L to 350 g/L, 300 g/L to 325 g/L, 325 g/L to 600 g/L, 350 g/L to 600 g/L, 375 g/L to 600 g/L, 400 g/L to 600 g/L, 425 g/L to 600 g/L, 450 g/L to 600 g/L, 475 g/L to 600 g/L, 500 g/L to 600 g/L, or 525 g/L to 600 g/L, or 550 g/L to 600 g/L.

In some embodiments, when the gas is phosphine, at a temperature of 21° C. and a pressure of 650 Torr or less, the activated pyrolyzed carbon component is configured to have a phosphine deliverable capacity of 150 g/L to 220 g/L, or any range or subrange between 150 g/L to 220 g/L. For example, in some embodiments, when the gas is phosphine, at a temperature of 21° C. and a pressure of 650 Torr or less, the activated pyrolyzed carbon component is configured to have a phosphine deliverable capacity of 150 g/L to 210 g/L, 150 g/L to 205 g/L, 150 g/L to 200 g/L, 150 g/L to 195 g/L, 150 g/L to 190 g/L, 150 g/L to 185 g/L, 150 g/L to 180 g/L, 150 g/L to 175 g/L, 150 g/L to 170 g/L, 150 g/L to 165 g/L, 150 g/L to 160 g/L, 150 g/L to 155 g/L, 155 g/L to 220 g/L, 160 g/L to 220 g/L, 165 g/L to 220 g/L, 170 g/L to 220 g/L, 175 g/L to 220 g/L, 180 g/L to 220 g/L, 185 g/L to 220 g/L, 190 g/L to 220 g/L, 195 g/L to 220 g/L, or 200 g/L to 220 g/L.

Some embodiments relate to an assembly. In some embodiments, the assembly comprises a vessel. In some embodiments, the vessel comprises a gas storage vessel. In some embodiments, the gas storage vessel comprises a vessel that is configured to receive, contain, and release a gas.

In some embodiments, the assembly comprises a sorbent material contained in an interior volume of the gas storage vessel. In some embodiments, the assembly comprises one or more sorbent materials contained in the interior volume of the gas storage vessel.

In some embodiments, the sorbent material fills at least 90% of the interior volume of the gas storage vessel. For example, in some embodiments, the sorbent material fills at least 91%, at least 92%, at least 93%, at least 94%, at least 95%, at least 96%, at least 97%, at least 98%, or at least 99% of the interior volume of the gas storage vessel.

In some embodiments, the sorbent material comprises a monolithic sorbent material. In some embodiments, the monolithic sorbent material is in the form of at least one of a puck, a brick, a cylinder, a block, or any combination thereof. In some embodiments, the monolithic sorbent material is not present in the form of a plurality of particles.

In some embodiments, the sorbent material comprises a carbon component. In some embodiments, the carbon component comprises a pyrolyzed carbon component. In some embodiments, the pyrolyzed carbon component comprises an activated pyrolyzed carbon component. In some embodiments, the activated pyrolyzed carbon component comprises any one or more of the activated pyrolyzed carbon components disclosed herein. For example, in some embodiments, the activated pyrolyzed carbon component comprises an activated pyrolyzed carbon component that, at a temperature of 21° C. and a pressure of 650 Torr or less, is configured to desorb at least 60% of a sorbed gas, as determined by a ratio of a gas deliverable capacity to a gas sorption capacity.

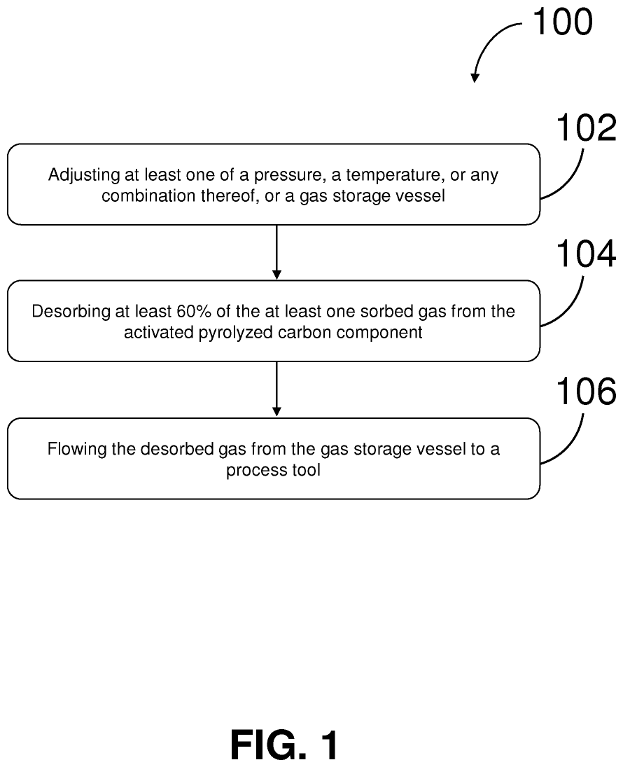

Some embodiments relate to a method. FIG. 1 is a flowchart of a method of delivering a gas 100, according to some embodiments. As shown in FIG. 1, the method of delivering a gas 100 may comprise any one or more of the following steps: adjusting 102 at least one of a pressure, a temperature, or any combination thereof, of a gas storage vessel; desorbing 104 at least 60% of the at least one sorbed gas from the activated pyrolyzed carbon component; and flowing 106 the desorbed gas from the gas storage vessel to a process tool.

At step 102, in some embodiments, the method comprises adjusting at least one of a pressure, a temperature, or any combination thereof, of a gas storage vessel. In some embodiments, the gas storage vessel comprises any one or more of the gas storage vessels disclosed herein. For example, in some embodiments, the gas storage vessel comprises a vessel configured to receive, contain, and release a gas.

In some embodiments, the gas storage vessel comprises an activated pyrolyzed carbon component. In some embodiments, the activated pyrolyzed carbon component comprises any one or more of the activated pyrolyzed carbon components disclosed herein. For example, in some embodiments, the activated pyrolyzed carbon component comprises an activated pyrolyzed carbon component that, at a temperature of 21° C. and a pressure of 650 Torr or less, is configured to desorb at least 60% of a sorbed gas, as determined by a ratio of a gas deliverable capacity to a gas sorption capacity.

In some embodiments, the gas storage vessel comprises at least one sorbed gas on the activated pyrolyzed carbon component. In some embodiments, the sorbed gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydrides, a halide compound, an organometallic compound, or any combination thereof.

In some embodiments, the adjusting comprises adjusting the pressure of the gas storage vessel. In some embodiments, the pressure is a pressure of 3 Torr to 650 Torr, or any range or subrange between 3 Torr to 650 Torr. For example, in some embodiments, the pressure is a pressure of 3 Torr to 600 Torr, 3 Torr to 550 Torr, 3 Torr to 500 Torr, 3 Torr to 450 Torr, 3 Torr to 400 Torr, 3 Torr to 350 Torr, 3 Torr to 300 Torr, 3 Torr to 250 Torr, 3 Torr to 200 Torr, 3 Torr to 150 Torr, 3 Torr to 100 Torr, 3 Torr to 90 Torr, 3 Torr to 80 Torr, 3 Torr to 70 Torr, 3 Torr to 60 Torr, 3 Torr to 50 Torr, 3 Torr to 40 Torr, 3 Torr to 30 Torr, 3 Torr to 20 Torr, 3 Torr to 10 Torr, 3 Torr to 5 Torr, 5 Torr to 650 Torr, 10 Torr to 650 Torr, 20 Torr to 650 Torr, 30 Torr to 650 Torr, 40 Torr to 650 Torr, 50 Torr to 650 Torr, 60 Torr to 650 Torr, 70 Torr to 650 Torr, 80 Torr to 650 Torr, 90 Torr to 650 Torr, 100 Torr to 650 Torr, 150 Torr to 650 Torr, 200 Torr to 650 Torr, 250 Torr to 650 Torr, 300 Torr to 650 Torr, 350 Torr to 650 Torr, 400 Torr to 650 Torr, 450 Torr to 650 Torr, 500 Torr to 650 Torr, 550 Torr to 650 Torr, or 600 Torr to 650 Torr.

In some embodiments, the adjusting comprises adjusting the temperature of the gas storage vessel. In some embodiments, the temperature is a temperature of 0° C. to 50° C., or any range or subrange between 0° C. to 50° C. For example, in some embodiments, the temperature is a temperature of 0° C. to 45° C., 0° C. to 40° C., 0° C. to 35° C., 0° C. to 30° C., 0° C. to 25° C., 0° C. to 20° C., 0° C. to 15° C., 0° C. to 10° C., 0° C. to 5° C., 5° C. to 50° C., 10° C. to 50° C., 15° C. to 50° C., 20° C. to 50° C., 25° C. to 50° C., 30° C. to 50° C., 35° C. to 50° C., 40° C. to 50° C., or 45° C. to 50° C. In some embodiments, the temperature is a temperature of 20° C. to 25° C., or any range or subrange between 20° C. to 25° C. For example, in some embodiments, the temperature is a temperature of 20° C., 21° C., 22° C., 23° C., 24° C., or 25° C.

At step 104, in some embodiments, the method comprises desorbing at least 60% of the at least one sorbed gas from the activated pyrolyzed carbon component. For example, in some embodiments, the method comprises desorbing at least 65%, at least 70%, at least 75%, at least 80%, at least 85%, at least 90%, at least 90%, or at least 99% of the at least one sorbed gas from the activated pyrolyzed carbon component.

In some embodiments, the method comprises desorbing 60% to 100%, or any range or subrange between 60% to 100%, of the at least one sorbed gas from the activated pyrolyzed carbon component. For example, in some embodiments, the method comprises desorbing 60% to 99%, 60% to 95%, 60% to 90%, 60% to 85%, 60% to 80%, 60% to 75%, 60% to 70%, 60% to 65%, 65% to 100%, 70% to 100%, 75% to 100%, 80% to 100%, 85% to 100%, 90% to 100%, 95% to 100%, or 99% to 100% of the at least one sorbed gas from the activated pyrolyzed carbon component.

At step 106, in some embodiments, the method comprises flowing the desorbed gas from the gas storage vessel to a process tool. In some embodiments, the process tool comprises a process tool for semiconductor manufacture. In some embodiments, the flowing comprises flowing the desorbed gas from the gas storage vessel to a process tool using at least one of a pipe, a conduit, a cabinet, or any combination thereof.

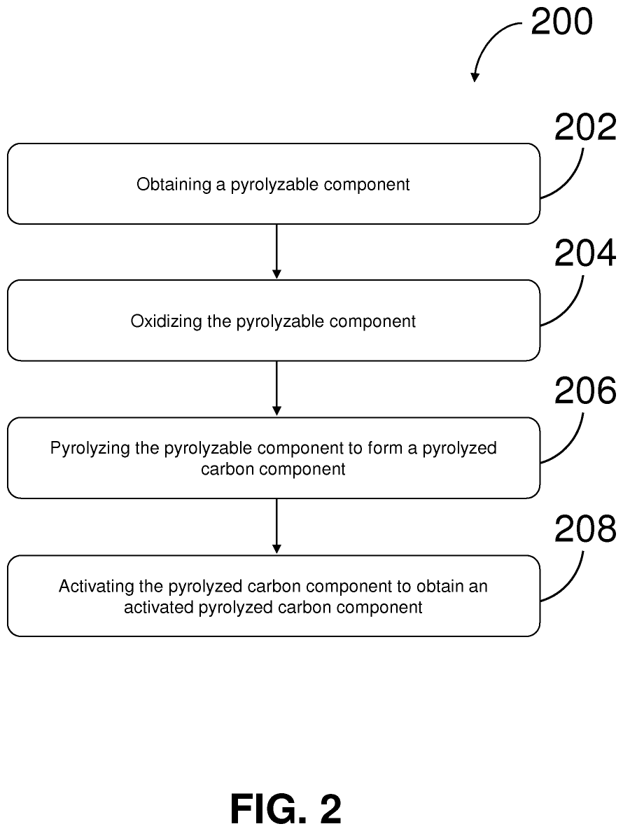

FIG. 2 is a flowchart of a method 200 for producing an activated pyrolyzed carbon component, according to some embodiments. As shown in FIG. 2, in some embodiments, the method 200 for producing an activated pyrolyzed carbon component may comprise any one or more of the following steps: obtaining 202 a pyrolyzable component, oxidizing 204 the pyrolyzable component, pyrolyzing 206 the pyrolyzable component to form a pyrolyzed carbon component, and activating 208 the pyrolyzed carbon component to obtain an activated pyrolyzed carbon component. As used herein, the term “pyrolyzable component” refers to a carbon-rich polymeric material that, upon thermal decomposition in an inert or controlled atmosphere, forms a carbonaceous residue. More particularly, the term “pyrolyzable component”, as used herein, refers to a polymeric precursor material, such as polyether ether ketone (PEEK), polyether ketone ketone (PEKK), polyphenylene oxide (PPO), or combinations thereof, that is capable of undergoing pyrolysis to form a pyrolyzed carbon component.

At step 202, in some embodiments, the method comprises obtaining a pyrolyzable component. In some embodiments, the obtaining 202 comprises pressing a pyrolyzable component into a disk. In some embodiments, the obtaining 202 comprises pressing a pyrolyzable component into a puck. In some embodiments, the obtaining 202 comprises obtaining a disk of a pyrolyzable component. In some embodiments, the obtaining 202 comprises obtaining a puck of a pyrolyzable component.

In some embodiments, the pyrolyzable component comprises at least one of a polyether ether ketone (PEEK), a polyether ketone ketone (PEKK), a polyphenylene oxide (PPO), or any combination thereof.

At step 204, in some embodiments, the method comprises oxidizing the pyrolyzable component. In some embodiments, the oxidizing 204 comprises oxidizing the pyrolyzable component using an oxidizing gas. In some embodiments, the oxidizing gas comprises an oxygen-containing gas. For example, in some embodiments, the oxidizing gas comprises at least one of air, carbon dioxide, O₂, O₃, or any combination thereof.

In some embodiments, the oxidizing 204 comprises oxidizing the pyrolyzable component with an oxidizing gas at a flow rate of 500 cc/min to 6000 cc/min, or any range or subrange between 500 cc/min to 6000 cc/min. For example, in some embodiments, the oxidizing 204 comprises oxidizing the pyrolyzable component with an oxidizing gas at a flow rate of 500 cc/min to 5500 cc/min, 500 cc/min to 5000 cc/min, 500 cc/min to 4500 cc/min, 500 cc/min to 4000 cc/min, 500 cc/min to 3500 cc/min, 500 cc/min to 3000 cc/min, 500 cc/min to 2500 cc/min, 500 cc/min to 2000 cc/min, 500 cc/min to 1500 cc/min, 500 cc/min to 1000 cc/min, 1000 cc/min to 6000 cc/min, 1500 cc/min to 6000 cc/min, 2000 cc/min to 6000 cc/min, 2500 cc/min to 6000 cc/min, 3000 cc/min to 6000 cc/min, 3500 cc/min to 6000 cc/min, 4000 cc/min to 6000 cc/min, 4500 cc/min to 6000 cc/min, 5000 cc/min to 6000 cc/min, or 5500 cc/min to 6000 cc/min.

In some embodiments, the oxidizing 204 comprises oxidizing at a temperature of 100° C. to 500° C., or any range or subrange between 100° C. to 500° C. For example, in some embodiments, the oxidizing 204 comprises oxidizing at a temperature of 100° C. to 475° C., 100° C. to 450° C., 100° C. to 425° C., 100° C. to 400° C., 100° C. to 375° C., 100° C. to 350° C., 100° C. to 325° C., 100° C. to 300° C., 100° C. to 275° C., 100° C. to 250° C., 100° C. to 225° C., 100° C. to 200° C., 100° C. to 175° C., 100° C. to 150° C., 100° C. to 125° C., 125° C. to 500° C., 150° C. to 500° C., 175° C. to 500° C., 200° C. to 500° C., 225° C. to 500° C., 250° C. to 500° C., 275° C. to 500° C., 300° C. to 500° C., 325° C. to 500° C., 350° C. to 500° C., 375° C. to 500° C., 400° C. to 500° C., 425° C. to 500° C., 450° C. to 500° C., or 475° C. to 500° C.

In some embodiments, the oxidizing 204 comprises oxidizing such that the pyrolyzable component has a burn-off of up to 50%. As used herein, the term “burn-off” refers to the percentage of the pyrolyzable component removed during oxidation and is calculated by taking the difference between the weight of the pyrolyzable component before oxidation and the weight of the pyrolyzable component after oxidation, dividing the difference by the weight of the pyrolyzable component before oxidation, and multiplying the result by 100%. In some embodiments, the oxidizing 204 comprises oxidizing such that the pyrolyzable component has a burn-off of up to 45%, up to 40%, up to 35%, up to 30%, up to 25%, up to 20%, up to 15%, or up to 10%. In some embodiments, the oxidizing 204 comprises oxidizing such that the pyrolyzable component has a burn-off of at least 5%.

In some embodiments, the oxidizing 204 comprises oxidizing such that the pyrolyzable component has a burn-off of 5% to 50%, or any range or subrange between 5% to 50%. For example, in some embodiments, the oxidizing 204 comprises oxidizing such that the pyrolyzable component has a burn-off of 5% to 49%, 5% to 48%, 5% to 47%, 5% to 46%, 5% to 45%, 5% to 44%, 5% to 43%, 5% to 42%, 5% to 41%, 5% to 40%, 5% to 39%, 5% to 38%, 5% to 37%, 5% to 36%, 5% to 35%, 5% to 34%, 5% to 33%, 5% to 32%, 5% to 31%, 5% to 30%, 5% to 29%, 5% to 28%, 5% to 27%, 5% to 26%, 5% to 25%, 5% to 24%, 5% to 23%, 5% to 22%, 5% to 21%, 5% to 20%, 5% to 19%, 5% to 18%, 5% to 17%, 5% to 16%, 5% to 15%, 5% to 14%, 5% to 13%, 5% to 12%, 5% to 11%, 5% to 10%, 5% to 9%, 5% to 8%, 5% to 7%, 5% to 6, 6% to 50%, 7% to 50%, 8% to 50%, 9% to 50%, 10% to 50%, 11% to 50%, 12% to 50%, 13% to 50%, 14% to 50%, 15% to 50%, 16% to 50%, 17% to 50%, 18% to 50%, 19% to 50%, 20% to 50%, 21% to 50%, 22% to 50%, 23% to 50%, 24% to 50%, 25% to 50%, 26% to 50%, 27% to 50%, 28% to 50%, 29% to 50%, 30% to 50%, 31% to 50%, 32% to 50%, 33% to 50%, 34% to 50%, 35% to 50%, 36% to 50%, 37% to 50%, 38% to 50%, 39% to 50%, 40% to 50%, 41% to 50%, 42% to 50%, 43% to 50%, 44% to 50%, 45% to 50%, 46% to 50%, 47% to 50%, 48% to 50%, or 49% to 50%.

At step 206, in some embodiments, the method comprises pyrolyzing the pyrolyzable component to form a pyrolyzed carbon component. In some embodiments, the pyrolyzing 206 comprises heating the pyrolyzable component to form a pyrolyzed carbon component. In some embodiments, the pyrolyzing 206 comprises pyrolyzing the pyrolyzable component at a temperature of 500° C. to 1000° C., or any range or subrange between 500° C. to 1000° C. For example, in some embodiments, the pyrolyzing 206 comprises pyrolyzing the pyrolyzable component at a temperature of 500° C. to 975° C., 500° C. to 950° C., 500° C. to 925° C., 500° C. to 900° C., 500° C. to 875° C., 500° C. to 850° C., 500° C. to 825° C., 500° C. to 800° C., 500° C. to 775° C., 500° C. to 750° C., 500° C. to 725° C., 500° C. to 700° C., 500° C. to 675° C., 500° C. to 650° C., 500° C. to 625° C., 500° C. to 600° C., 500° C. to 575° C., 500° C. to 550° C., 500° C. to 525° C., 525° C. to 1000° C., 550° C. to 1000° C., 575° C. to 1000° C., 600° C. to 1000° C., 625° C. to 1000° C., 650° C. to 1000° C., 675° C. to 1000° C., 700° C. to 1000° C., 725° C. to 1000° C., 750° C. to 1000° C., 775° C. to 1000° C., 800° C. to 1000° C., 825° C. to 1000° C., 850° C. to 1000° C., 875° C. to 1000° C., 900° C. to 1000° C., 925° C. to 1000° C., 950° C. to 1000° C., or 975° C. to 1000° C.

At step 208, in some embodiments, the method comprises activating the pyrolyzed carbon component to obtain an activated pyrolyzed carbon component. Activation increases the porosity and surface area of the pyrolyzed carbon component by selective oxidative etching of reactive carbon atoms to create, enlarge, or open micropores, thereby enhancing the gas sorption and desorption characteristics of the material. In some embodiments, the activating 208 comprises activating the pyrolyzed carbon by using an activating gas. In some embodiments, an activating gas comprises at least one of carbon monoxide, carbon dioxide, water vapor, air, or any combination thereof. In some embodiments, the activating 208 comprises activating the pyrolyzed carbon by using an activating gas at a flow rate of 500 cc/min to 6000 cc/min, or any range or subrange between 500 cc/min to 6000 cc/min. For example, in some embodiments, the activating 208 comprises activating the pyrolyzed carbon by using an activating gas at a flow rate of 500 cc/min to 5500 cc/min, 500 cc/min to 5000 cc/min, 500 cc/min to 4500 cc/min, 500 cc/min to 4000 cc/min, 500 cc/min to 3500 cc/min, 500 cc/min to 3000 cc/min, 500 cc/min to 2500 cc/min, 500 cc/min to 2000 cc/min, 500 cc/min to 1500 cc/min, 500 cc/min to 1000 cc/min, 1000 cc/min to 6000 cc/min, 1500 cc/min to 6000 cc/min, 2000 cc/min to 6000 cc/min, 2500 cc/min to 6000 cc/min, 3000 cc/min to 6000 cc/min, 3500 cc/min to 6000 cc/min, 4000 cc/min to 6000 cc/min, 4500 cc/min to 6000 cc/min, 5000 cc/min to 6000 cc/min, or 5500 cc/min to 6000 cc/min.

In some embodiments, the activating 208 comprises activating the pyrolyzed carbon by using an activating gas at a temperature of 500° C. to 1000° C., or any range or subrange between 500° C. to 1000° C. For example, in some embodiments, the activating 208 comprises activating the pyrolyzed carbon by using an activating gas at a temperature of 500° C. to 975° C., 500° C. to 950° C., 500° C. to 925° C., 500° C. to 900° C., 500° C. to 875° C., 500° C. to 850° C., 500° C. to 825° C., 500° C. to 800° C., 500° C. to 775° C., 500° C. to 750° C., 500° C. to 725° C., 500° C. to 700° C., 500° C. to 675° C., 500° C. to 650° C., 500° C. to 625° C., 500° C. to 600° C., 500° C. to 575° C., 500° C. to 550° C., 500° C. to 525° C., 525° C. to 1000° C., 550° C. to 1000° C., 575° C. to 1000° C., 600° C. to 1000° C., 625° C. to 1000° C., 650° C. to 1000° C., 675° C. to 1000° C., 700° C. to 1000° C., 725° C. to 1000° C., 750° C. to 1000° C., 775° C. to 1000° C., 800° C. to 1000° C., 825° C. to 1000° C., 850° C. to 1000° C., 875° C. to 1000° C., 900° C. to 1000° C., 925° C. to 1000° C., 950° C. to 1000° C., or 975° C. to 1000° C.

In some embodiments, the activating 208 comprises heating the pyrolyzed carbon component at a temperature of 500 to 1200° C., or any range or subrange between 500° C. to 1200° C. For example, in some embodiments, the activating 208 comprises heating the pyrolyzed carbon component at a temperature of 500° C. to 1175° C., 500° C. to 1150° C., 500° C. to 1125° C., 500° C. to 1100° C., 500° C. to 1075° C., 500° C. to 1050° C., 500° C. to 1025° C., 500° C. to 1000° C., 500° C. to 975° C., 500° C. to 950° C., 500° C. to 925° C., 500° C. to 900° C., 500° C. to 875° C., 500° C. to 850° C., 500° C. to 825° C., 500° C. to 800° C., 500° C. to 775° C., 500° C. to 750° C., 500° C. to 725° C., 500° C. to 700° C., 500° C. to 675° C., 500° C. to 650° C., 500° C. to 625° C., 500° C. to 600° C., 500° C. to 575° C., 500° C. to 550° C., 500° C. to 525° C., 525° C. to 1200° C., 550° C. to 1200° C., 575° C. to 1200° C., 600° C. to 1200° C., 625° C. to 1200° C., 650° C. to 1200° C., 675° C. to 1200° C., 700° C. to 1200° C., 725° C. to 1200° C., 750° C. to 1200° C., 775° C. to 1200° C., 800° C. to 1200° C., 825° C. to 1200° C., 850° C. to 1200° C., 875° C. to 1200° C., 900° C. to 1200° C., 925° C. to 1200° C., 950° C. to 1200° C., 975° C. to 1200° C., 1000° C. to 1200° C., 1025° C. to 1200° C., 1050° C. to 1200° C., 1075° C. to 1200° C., 1100° C. to 1200° C., 1125° C. to 1200° C., 1150° C. to 1200° C., or 1175° C. to 1200° C.

In some embodiments, the activated pyrolyzed carbon component has a density of 0.75 g/cm³ to 1.2 g/cm³, or any range or subrange between 0.75 g/cm³ to 1.2 g/cm³. For example, in some embodiments, the activated pyrolyzed carbon component has a density of 0.75 g/cm³ to 1.1 g/cm³, 0.75 g/cm³ to 1.0 g/cm³, 0.75 g/cm³ to 0.9 g/cm³, 0.75 g/cm³ to 0.8 g/cm³, 0.8 g/cm³ to 1.2 g/cm³, 0.9 g/cm³ to 1.2 g/cm³, 1.0 g/cm³ to 1.2 g/cm³, or 1.1 g/cm³ to 1.2 g/cm³.

In some embodiments, the activated pyrolyzed carbon component comprises a porous activated pyrolyzed carbon component. In some embodiments, the activated pyrolyzed carbon component has a porosity of at least 40%. For example, in some embodiments, the activated pyrolyzed carbon component has a porosity of at least 45%, at least 50%, at least 55%, at least 60%, at least 65%, at least 70%, at least 75%, at least 80%, at least 85%, or at least 90%. In some embodiments, the activated pyrolyzed carbon component has a porosity of 40% to 90%, or any range or subrange between 40% to 90%. For example, in some embodiments, the activated pyrolyzed carbon component has a porosity of 40% to 85%, 40% to 80%, 40% to 75%, 40% to 70%, 40% to 65%, 40% to 60%, 40% to 55%, 40% to 50%, 40% to 45%, 45% to 90%, 50% to 90%, 55% to 90%, 60% to 90%, 65% to 90%, 70% to 90%, 75% to 90%, 80% to 90%, or 85% to 90%.

In some embodiments, the activated pyrolyzed carbon component has a pore size distribution of 0.7 nm to 2.5 nm, or any range or subrange between 0.7 nm to 2.5 nm. For example, in some embodiments, the activated pyrolyzed carbon component has a pore size distribution of 0.7 nm to 2.4 nm, 0.7 nm to 2.3 nm, 0.7 nm to 2.2 nm, 0.7 nm to 2.1 nm, 0.7 nm to 2.0 nm, 0.7 nm to 1.9 nm, 0.7 nm to 1.8 nm, 0.7 nm to 1.7 nm, 0.7 nm to 1.6 nm, 0.7 nm to 1.5 nm, 0.7 nm to 1.4 nm, 0.7 nm to 1.3 nm, 0.7 nm to 1.2 nm, 0.7 nm to 1.1 nm, 0.7 nm to 1 nm, 0.7 nm to 0.9 nm, 0.7 nm to 0.8 nm, 0.8 nm to 2.5 nm, 0.9 nm to 2.5 nm, 1 nm to 2.5 nm, 1.1 nm to 2.5 nm, 1.2 nm to 2.5 nm, 1.3 nm to 2.5 nm, 1.4 nm to 2.5 nm, 1.5 nm to 2.5 nm, 1.6 nm to 2.5 nm, 1.7 nm to 2.5 nm, 1.8 nm to 2.5 nm, 1.9 nm to 2.5 nm, 2.0 nm to 2.5 nm, 2.1 nm to 2.5 nm, 2.2 nm to 2.5 nm, 2.3 nm to 2.5 nm, or 2.4 nm to 2.5 nm. In some embodiments, an ASAP 2024 micromeritics instrument is utilized to run N₂ adsorption at 77 K to measure surface area and pore size distribution. In some embodiments, the pore size distribution is a density functional theory (DFT) pore size distribution. In some embodiments, the DFT methodology used to determine the pore size distribution include at least one of Dubinin-Astakhov (D-A), Dubinin-Radushkevich (D-R), Horvath-Kawazoe (H-K), or any combination thereof.

In some embodiments, the activated pyrolyzed carbon component has a BET volumetric surface area of 800 m²/cc to 1600 m²/cc, or any range or subrange between 800 m²/cc to 1600 m²/cc. For example, in some embodiments, the activated pyrolyzed carbon component has a BET volumetric surface area of 800 m²/cc to 1550 m²/cc, 800 m²/cc to 1500 m²/cc, 800 m²/cc to 1450 m²/cc, 800 m²/cc to 1400 m²/cc, 800 m²/cc to 1350 m²/cc, 800 m²/cc to 1300 m²/cc, 800 m²/cc to 1250 m²/cc, 800 m²/cc to 1200 m²/cc, 800 m²/cc to 1150 m²/cc, 800 m²/cc to 1100 m²/cc, 800 m²/cc to 1050 m²/cc, 800 m²/cc to 1000 m²/cc, 800 m²/cc to 950 m²/cc, 800 m²/cc to 900 m²/cc, 800 m²/cc to 850 m²/cc, 850 m²/cc to 1600 m²/cc, 900 m²/cc to 1600 m²/cc, 950 m²/cc to 1600 m²/cc, 1000 m²/cc to 1600 m²/cc, 1050 m²/cc to 1600 m²/cc, 1100 m²/cc to 1600 m²/cc, 1150 m²/cc to 1600 m²/cc, 1200 m²/cc to 1600 m²/cc, 1250 m²/cc to 1600 m²/cc, 1300 m²/cc to 1600 m²/cc, 1350 m²/cc to 1600 m²/cc, 1400 m²/cc to 1600 m²/cc, 1450 m²/cc to 1600 m²/cc, 1500 m²/cc to 1600 m²/cc, or 1550 m²/cc to 1600 m²/cc.

In some embodiments, the activated pyrolyzed carbon component comprises a monolithic activated pyrolyzed carbon component. In some embodiments, the monolithic activated pyrolyzed carbon component is in the form of at least one of a puck, a brick, a cylinder, a block, or any combination thereof. In some embodiments, the monolithic activated pyrolyzed carbon component is not present in the form of a plurality of particles. In some embodiments, the monolithic activated pyrolyzed carbon component is free of cracks.

In some embodiments, the monolithic activated pyrolyzed carbon component has at least one dimension in a range of 1 mm to 200 mm, or any range or subrange between 1 mm to 200 mm. For example, in some embodiments, the monolithic activated pyrolyzed carbon component has at least one dimension in a range of 1 mm to 190 mm, 1 mm to 180 mm, 1 mm to 170 mm, 1 mm to 160 mm, 1 mm to 150 mm, 1 mm to 140 mm, 1 mm to 130 mm, 1 mm to 120 mm, 1 mm to 110 mm, 1 mm to 100 mm, 1 mm to 90 mm, 1 mm to 80 mm, 1 mm to 70 mm, 1 mm to 60 mm, 1 mm to 50 mm, 1 mm to 40 mm, 1 mm to 30 mm, 1 mm to 20 mm, 1 mm to 10 mm, 10 mm to 200 mm, 20 mm to 200 mm, 30 mm to 200 mm, 40 mm to 200 mm, 50 mm to 200 mm, 60 mm to 200 mm, 70 mm to 200 mm, 80 mm to 200 mm, 90 mm to 200 mm, 100 mm to 200 mm, 110 mm to 200 mm, 120 mm to 200 mm, 130 mm to 200 mm, 140 mm to 200 mm, 150 mm to 200 mm, 160 mm to 200 mm, 170 mm to 200 mm, 180 mm to 200 mm, or 190 mm to 200 mm.

In some embodiments, the at least one dimension comprises at least one of a length, a width, a diameter, a thickness, or any combination thereof. In some embodiments, at least one dimension comprises a diameter and a thickness. In some embodiments, at least one dimension comprises at least one dimension of a cylindrical shape.

In some embodiments, when contained in a gas storage vessel, the activated pyrolyzed carbon component is configured to sorb and desorb a sorbed gas. In some embodiments, at a temperature of 21° C. and a pressure of 650 Torr or less, the activated pyrolyzed carbon component is configured to desorb at least 60% of a sorbed gas, as determined by a ratio of a gas deliverable capacity to a gas sorption capacity. For example, in some embodiments, at a temperature of 21° C. and a pressure of 650 Torr or less, the activated pyrolyzed carbon component is configured to desorb at least 65%, at least 70%, at least 75%, at least 80%, at least 85%, at least 90%, at least 95%, or at least 99% of a sorbed gas, as determined by a ratio of a gas deliverable capacity to a gas sorption capacity.

In some embodiments, at a temperature of 21° C. and a pressure of 650 Torr or less, the activated pyrolyzed carbon component is configured to desorb 60% to 100% of a sorbed gas, as determined by a ratio of a gas deliverable capacity to a gas sorption capacity. For example, in some embodiments, at a temperature of 21° C. and a pressure of 650 Torr or less, the activated pyrolyzed carbon component is configured to desorb 60% to 99%, 60% to 95%, 60% to 90%, 60% to 85%, 60% to 80%, 60% to 75%, 60% to 70%, 60% to 65%, 65% to 100%, 70% to 100%, 75% to 100%, 80% to 100%, 85% to 100%, 90% to 100%, 95% to 100%, or 99% to 100% of a sorbed gas, as determined by a ratio of a gas deliverable capacity to a gas sorption capacity.

In some embodiments, the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydrides, a halide compound, an organometallic compound, or any combination thereof.

In some embodiments, at a temperature of 21° C. and a pressure of 650 Torr or less, the activated pyrolyzed carbon component is configured to have a gas deliverable capacity of 150 g/L to 650 g/L, or any range or subrange between 150 g/L to 650 g/L. For example, at a temperature of 21° C. and a pressure of 650 Torr or less, the activated pyrolyzed carbon component is configured to have a gas deliverable capacity of 150 g/L to 625 g/L, 150 g/L to 600 g/L, 150 g/L to 575 g/L, 150 g/L to 550 g/L, 150 g/L to 525 g/L, 150 g/L to 500 g/L, 150 g/L to 475 g/L, 150 g/L to 450 g/L, 150 g/L to 425 g/L, 150 g/L to 400 g/L, 150 g/L to 375 g/L, 150 g/L to 350 g/L, 150 g/L to 325 g/L, 150 g/L to 300 g/L, 150 g/L to 275 g/L, 150 g/L to 250 g/L, 150 g/L to 225 g/L, 150 g/L to 200 g/L, 150 g/L to 175 g/L, 175 g/L to 650 g/L, 200 g/L to 650 g/L, 225 g/L to 650 g/L, 250 g/L to 650 g/L, 275 g/L to 650 g/L, 300 g/L to 650 g/L, 325 g/L to 650 g/L, 350 g/L to 650 g/L, 375 g/L to 650 g/L, 400 g/L to 650 g/L, 425 g/L to 650 g/L, 450 g/L to 650 g/L, 475 g/L to 650 g/L, 500 g/L to 650 g/L, 525 g/L to 650 g/L, 550 g/L to 650 g/L, 575 g/L to 650 g/L, 600 g/L to 650 g/L, or 625 g/L to 650 g/L.

In some embodiments, the gas deliverable capacity is dependent on the gas. For example, in some embodiments, when the gas is arsine, at a temperature of 21° C. and a pressure of 650 Torr or less, the activated pyrolyzed carbon component is configured to have an arsine deliverable capacity of 300 g/L to 550 g/L, or any range or subrange between 300 g/L to 550 g/L. In some embodiments, when the gas is arsine, at a temperature of 21° C. and a pressure of 650 Torr or less, the activated pyrolyzed carbon component is configured to have an arsine deliverable capacity of 300 g/L to 525 g/L, 300 g/L to 500 g/L, 300 g/L to 475 g/L, 300 g/L to 450 g/L, 300 g/L to 425 g/L, 300 g/L to 400 g/L, 300 g/L to 375 g/L, 300 g/L to 350 g/L, 300 g/L to 325 g/L, 325 g/L to 550 g/L, 350 g/L to 550 g/L, 375 g/L to 550 g/L, 400 g/L to 550 g/L, 425 g/L to 550 g/L, 450 g/L to 550 g/L, 475 g/L to 550 g/L, 500 g/L to 550 g/L, or 525 g/L to 550 g/L.

In some embodiments, when the gas is phosphine, at a temperature of 21° C. and a pressure of 650 Torr or less, the activated pyrolyzed carbon component is configured to have a phosphine deliverable capacity of 150 g/L to 200 g/L, or any range or subrange between 150 g/L to 200 g/L. For example, in some embodiments, when the gas is phosphine, at a temperature of 21° C. and a pressure of 650 Torr or less, the activated pyrolyzed carbon component is configured to have a phosphine deliverable capacity of 150 g/L to 195 g/L, 150 g/L to 190 g/L, 150 g/L to 185 g/L, 150 g/L to 180 g/L, 150 g/L to 175 g/L, 150 g/L to 170 g/L, 150 g/L to 165 g/L, 150 g/L to 160 g/L, 150 g/L to 155 g/L, 155 g/L to 200 g/L, 160 g/L to 200 g/L, 165 g/L to 200 g/L, 170 g/L to 200 g/L, 175 g/L to 200 g/L, 180 g/L to 200 g/L, 185 g/L to 200 g/L, 190 g/L to 200 g/L, or 195 g/L to 200 g/L.

Any one or more of the embodiments disclosed herein shall be understood to be combinable without departing from the scope or spirit of the disclosure.

### Example 1

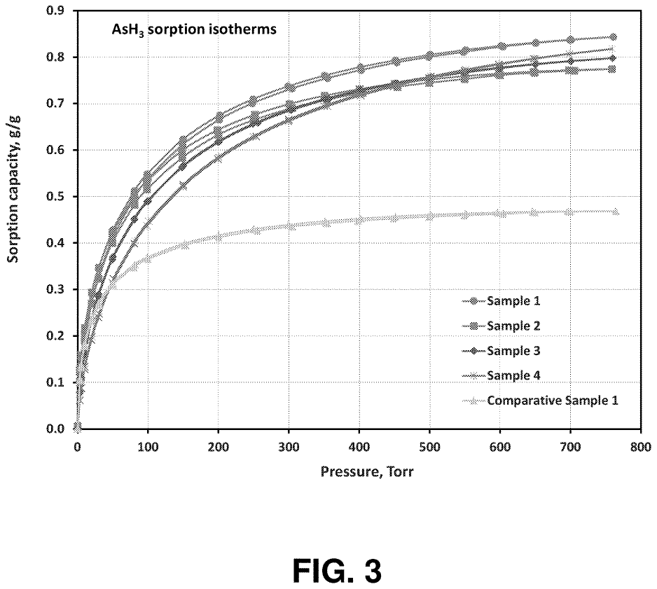

Samples 1-4 and Comparative Sample 1 were monolithic activated pyrolyzed carbon components. Samples 1-4 used PVDC as a starting material and were activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Samples 1~4 had a percent burn-off of 10% to 40%. Comparative Sample 1 used PVDC as a starting material and was not activated using this method. Arsine (AsH₃) sorption isotherms were obtained by locating each sample in a separate gas storage vessel and charging each gas storage vessel with arsine gas at a temperature of 21° C. and measuring the sorption capacity of each sample over a pressure range of 0 Torr to 760 Torr. The results are shown in FIG. 3. As can be seen in FIG. 3, Sample 1-4 have a much higher arsine sorption capacity than Comparative Sample 1.

### Example 2

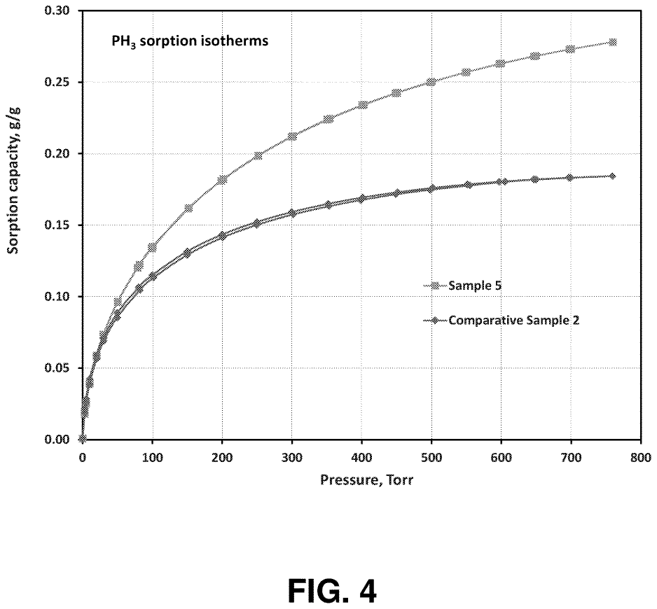

Sample 5 and Comparative Sample 2 were monolithic activated pyrolyzed carbon components. Sample 5 used PVDC as a starting material and was activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Sample 5 had a percent burn-off of 10% to 40%. Comparative Sample 2 used PVDC as a starting material and was not activated using this method. Phosphine (PH3) sorption isotherms were obtained by locating each sample in a separate gas storage vessel and charging each gas storage vessel with phosphine gas at a temperature of 21° C. and measuring the sorption capacity of each sample over a pressure range of 0 Torr to 760 Torr. The results are shown in FIG. 4. As can be seen in FIG. 4, Sample 5 has a much higher phosphine sorption capacity than Comparative Sample 2.

### Example 3

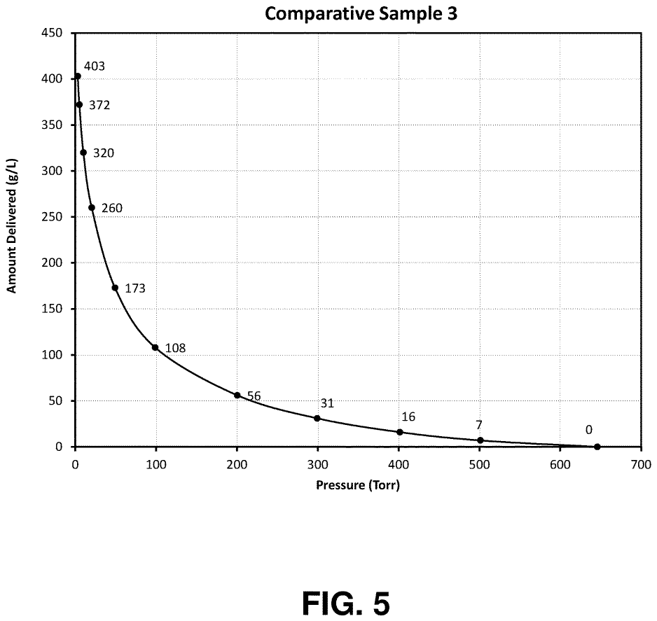

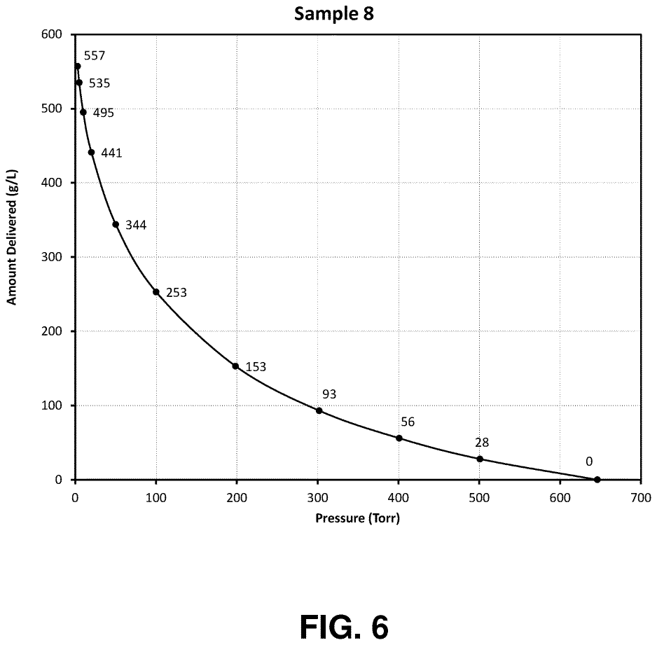

Samples 6-8 and Comparative Sample 3 were monolithic activated pyrolyzed carbon components. Samples 6-8 used PVDC as a starting material and were activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Samples 6-8 had a percent burn-off of 10% to 40%. Comparative Sample 3 used PVDC as a starting material and was not activated using this method. The deliverable amount of arsine gas for each sample was determined by locating each sample in a separate gas storage vessel, charging to capacity each gas storage vessel with arsine gas at a temperature of 21° C. and a pressure of 650 Torr or greater, and then measuring the amount of arsine gas delivered from the gas storage vessel at a temperature of 21° C. over a pressure range of 650 Torr to 3 Torr. The results for the amount of arsine gas delivered in g/L at various pressures for each sample are shown in Table 1. The amounts of arsine gas delivered over the entire pressure range for Comparative Sample 3 and Sample 8 are shown in FIG. 5 and FIG. 6, respectively.

TABLE 1

| | Arsine | | | |
|---|---|---|---|---|
| | delivery | Arsine | Arsine | Arsine |
| | Comparative | delivery | delivery | delivery |
| Pressure | Sample 3 | Sample 6 | Sample 7 | Sample 8 |
| (Torr) | (g/L) | (g/L) | (g/L) | (g/L) |
| 20 | 260 | 439 | 444 | 441 |
| 10 | 320 | 506 | 503 | 495 |
| 5 | 372 | 552 | 547 | 535 |
| 3 | 403 | 578 | 570 | 557 |

As can be seen in Table 1, Samples 6-8 had much higher arsine gas deliverable amounts than Comparative Sample 3.

### Example 4

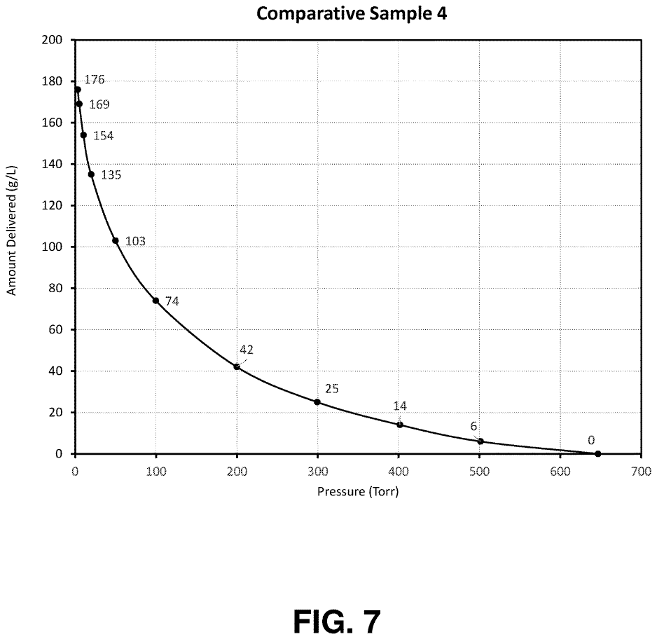

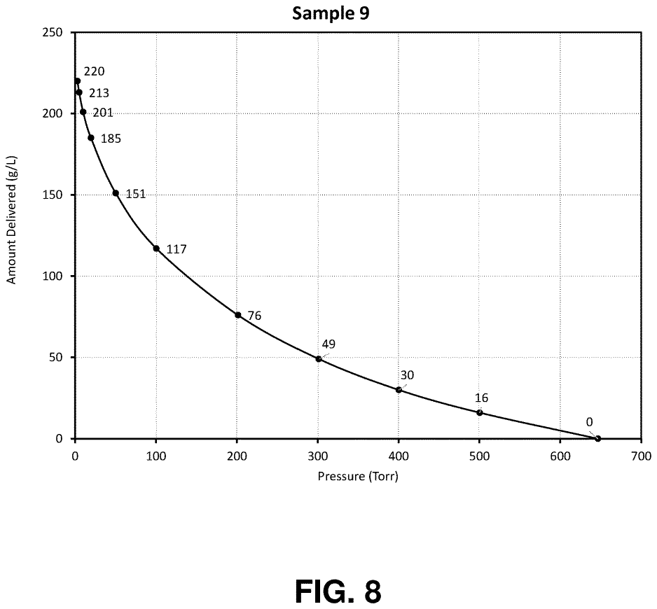

Sample 9 and Comparative Sample 4 were monolithic activated pyrolyzed carbon components. Sample 9 used PVDC as a starting material and was activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Sample 9 had a percent burn-off of 10% to 40%. Comparative Sample 4 used PVDC as a starting material and was not activated using this method. The deliverable amount of phosphine gas for each sample was determined by locating each sample in a separate gas storage vessel, charging to capacity each gas storage vessel with phosphine gas at a temperature of 21° C. and a pressure of 650 Torr or greater, and then measuring the amount of phosphine gas delivered from the gas storage vessel at a temperature of 21° C. over a pressure range of 650 Torr to 3 Torr. The results for the amount of phosphine gas delivered in g/L at various pressures for each sample are shown in Table 2. The amounts of phosphine gas delivered over the entire pressure range for Comparative Sample 4 and Sample 9 are shown in FIG. 7 and FIG. 8, respectively.

TABLE 2

| | Phosphine | |
|---|---|---|
| | delivery | Phosphine |
| | Comparative | delivery |
| | Sample 4 | Sample 9 |
| Pressure (Torr) | (g/L) | (g/L) |
| 20 | 135 | 185 |
| 10 | 154 | 201 |
| 5 | 169 | 213 |
| 3 | 176 | 220 |

As can be seen in Table 2, Sample 9 had a much higher phosphine gas deliverable amount than Comparative Sample 4.

### Example 5

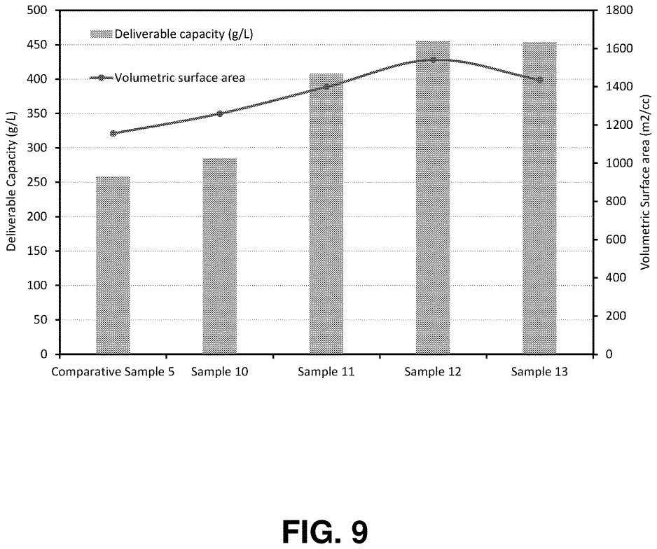

Samples 10-13 and Comparative Sample 5 were monolithic activated pyrolyzed carbon components. Samples 10-13 used PVDC as a starting material and were activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Samples 10-13 had a percent burn-off of 10% to 40%. Comparative Sample 5 used PVDC as a starting material and was not activated using this method. The BET volumetric surface area for each sample was measured. The results are shown in Table 3. The amount of arsine gas sorbed by each sample was measured by locating each sample in a separate gas storage vessel and charging to capacity each gas storage vessel with arsine gas at 21° C. and 650 Torr. The results are shown in Table 3 as the arsine sorption capacity. The amount of arsine gas delivered from the gas storage vessel was measured by adjusting the pressure of the gas storage vessel from 650 Torr to 20 Torr and measuring the amount of arsine gas delivered at 21° C. over the pressure range. The results are shown in Table 3 as the arsine deliverable capacity. Additionally, Table 3 shows the percentage of sorbed arsine gas that was desorbed as a ratio of the arsine deliverable capacity to the arsine sorption capacity. FIG. 9 shows the BET volumetric surface area and the arsine deliverable capacity for Comparative Sample 5 and Samples 10-13.

TABLE 3

| | BET | Arsine | Arsine | % of sorbed |
|---|---|---|---|---|
| | Volumetric | Sorption | Deliverable | arsine gas |
| | Surface Area | Capacity | Capacity | that was |
| Sample | (m²/mL) | (g/L) | (g/L) | desorbed |
| Comparative | 1155 | 520 | 258 | 50% |
| Sample 5 | | | | |
| Sample 10 | 1259 | 550 | 285 | 52% |
| Sample 11 | 1399 | 650 | 408 | 63% |
| Sample 12 | 1541 | 700 | 455 | 65% |
| Sample 13 | 1435 | 640 | 453 | 71% |

As shown in Table 3 and FIG. 9, as the BET volumetric surface area increases, the deliverable capacity (from 650 Torr to 20 Torr) also increases.

### Example 6

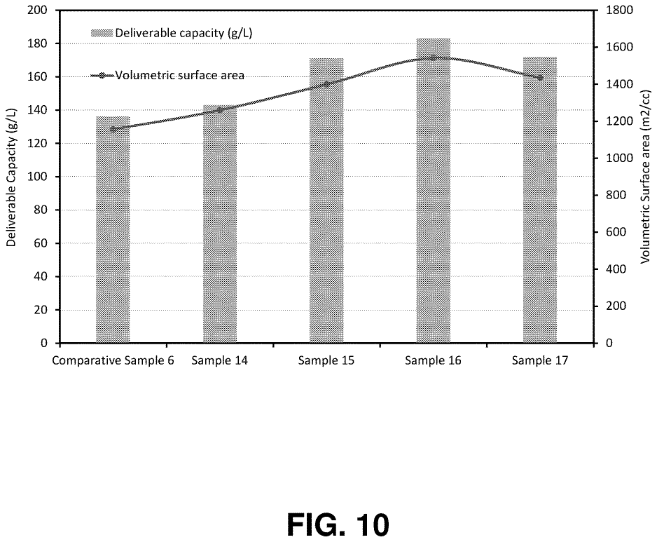

Samples 14-17 and Comparative Sample 6 were monolithic activated pyrolyzed carbon components. Samples 14-17 used PVDC as a starting material and were activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Samples 14-17 had a percent burn-off of 10% to 40%. Comparative Sample 6 used PVDC as a starting material and was not activated using this method. The BET volumetric surface area for each sample was measured. The results are shown in Table 4. The amount of phosphine gas sorbed by each sample was measured by locating each sample in a separate gas storage vessel and charging to capacity each gas storage vessel with phosphine gas at 21° C. and 650 Torr. The results are shown in Table 4 as the phosphine sorption capacity. The amount of phosphine gas delivered from the gas storage vessel was measured by adjusting the pressure of the gas storage vessel from 650 Torr to 20 Torr and measuring the amount of phosphine gas delivered at 21° C. over the pressure range. The results are shown in Table 4 as the phosphine deliverable capacity. Additionally, Table 4 shows the percentage of sorbed phosphine gas that was desorbed as a ratio of the phosphine deliverable capacity to the phosphine sorption capacity. FIG. 10 shows the BET volumetric surface area and the phosphine deliverable capacity for Comparative Sample 6 and Sample 14-17.

TABLE 4

| | BET | Phosphine | Phosphine | % of sorbed |
|---|---|---|---|---|
| | Volumetric | Sorption | Deliverable | phosphine |
| | Surface Area | Capacity | Capacity | gas that was |
| Sample | (m²/mL) | (g/L) | (g/L) | desorbed |
| Comparative | 1155 | 200 | 136 | 68% |
| Sample 6 | | | | |
| Sample 14 | 1259 | 224 | 143 | 64% |
| Sample 15 | 1399 | 224 | 171 | 76% |
| Sample 16 | 1541 | 235 | 183 | 78% |
| Sample 17 | 1435 | 219 | 172 | 79% |

As shown in Table 4 and FIG. 10, as the BET volumetric surface area increases, the deliverable capacity (from 650 Torr to 20 Torr) also increases.

### Example 7

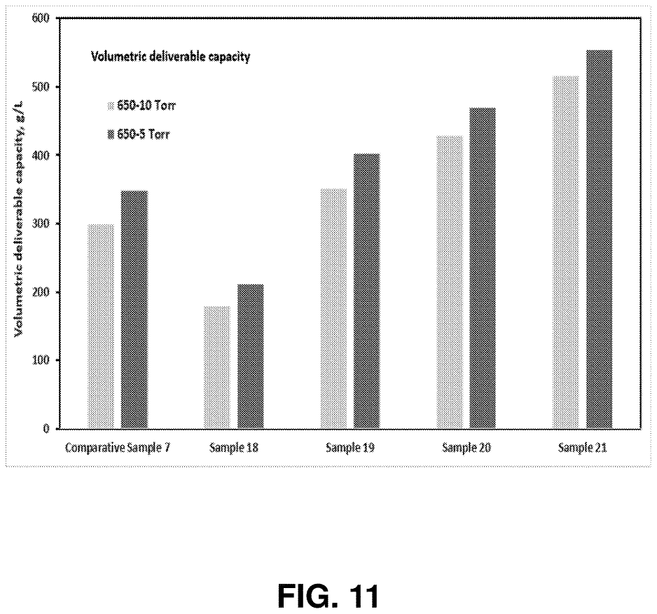

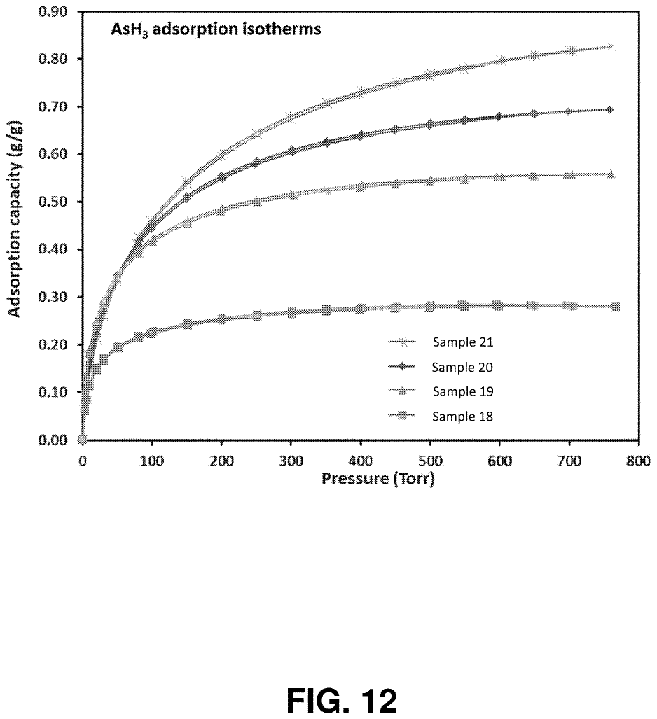

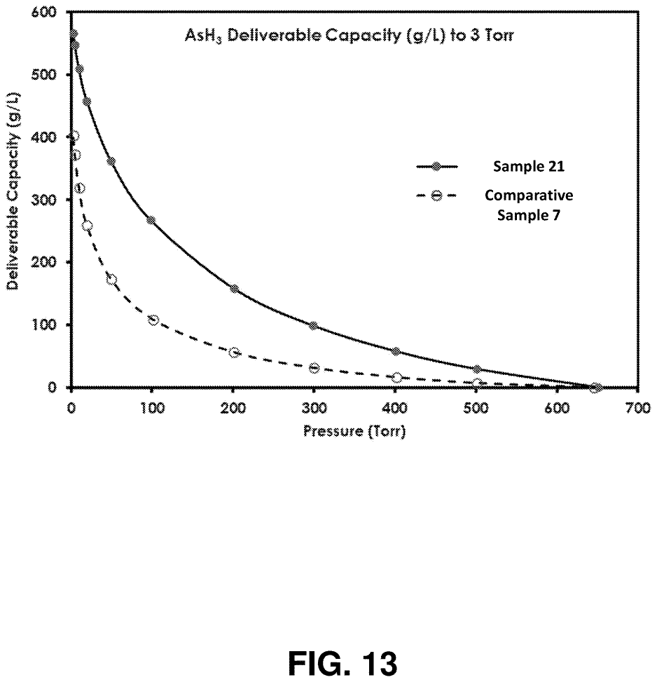

Samples 18-21 and Comparative Sample 7 were monolithic activated pyrolyzed carbon components. Samples 18-21 were obtained from PEEK as the starting material, i.e., pyrolyzable carbon component and Comparative Sample 7 was obtained from PVDC as the starting material. Samples 18-21 were activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Comparative Sample 7 was not activated using this method. The density of each sample was measured. The results are shown in Table 5. The amount of arsine gas sorbed by each sample was measured by locating each sample in a separate gas storage vessel and charging to capacity each gas storage vessel with arsine gas at 21° C. and 650 Torr. The results are shown in Table 5 as the arsine sorption capacity. The amount of arsine gas delivered from the gas storage vessel was measured by adjusting the pressure of the gas storage vessel from 650 Torr to 3 Torr and measuring the amount of arsine gas delivered at 21° C. over the pressure range. The results for the pressure range of 650 Torr to 10 Torr are shown in Table 5 as the arsine deliverable capacity. Additionally, Table 5 shows the percentage of sorbed arsine gas that was desorbed as a ratio of the arsine deliverable capacity to the arsine sorption capacity. The volumetric deliverable capacity over the pressure ranges of 650 Torr to 10 Torr and 650 Torr to 5 Torr for each sample are shown in FIG. 11. Further, Arsine (AsH₃) sorption isotherms for Sample 18-21 were obtained by locating each sample in a separate gas storage vessel and charging each gas storage vessel with arsine gas at a temperature of 21° C. and measuring the sorption capacity of each sample over a pressure range of 0 Torr to 760 Torr. The results are shown in FIG. 12. The amounts of arsine gas delivered over the entire pressure range for Comparative Sample 7 and Sample 21 are shown in FIG. 13.

TABLE 5

| | | Arsine | Arsine | |
|---|---|---|---|---|
| | | Sorption | Deliverable | % of sorbed |
| | Density | Capacity | Capacity | arsine gas that |
| Sample | (g/cc) | (g/L) | (g/L) | was desorbed |
| Comparative | 1.10 | 512.6 | 310.2 | 61% |
| Sample 7 | | | | |
| Sample 18 | 1.21 | 342.4 | 177.9 | 52% |
| Sample 19 | 0.96 | 533.8 | 351.4 | 66% |
| Sample 20 | 0.82 | 562.5 | 428.0 | 76% |
| Sample 21 | 0.77 | 622.2 | 509.0 | 82% |

As shown in Table 5, as the density decreases, the deliverable capacity (from 650 Torr to 10 Torr) increases. As can be seen, the process results in a structural change that produces higher porosity, thus a decrease in density and a higher gas storage and deliverable.

### Example 8

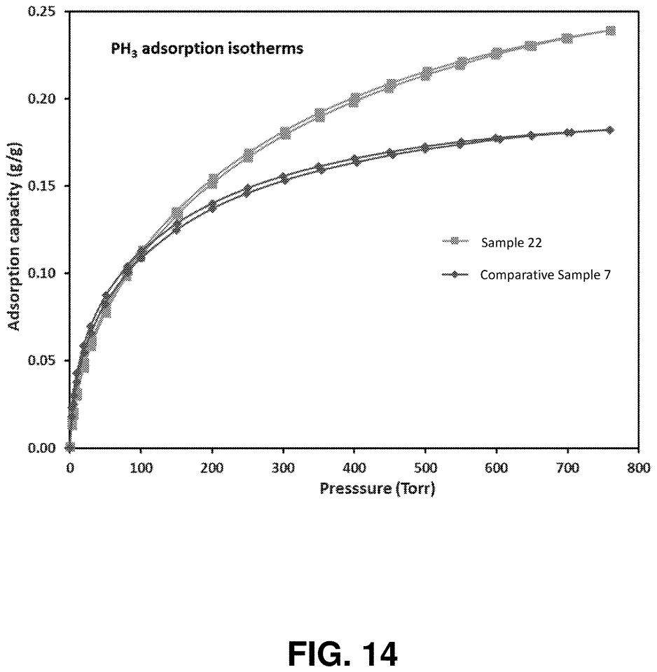

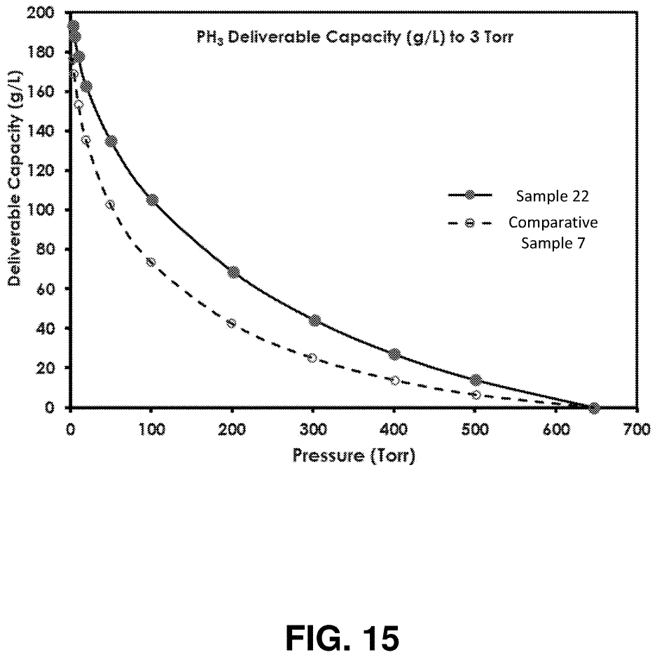

Sample 22 and Comparative Sample 7 were monolithic activated pyrolyzed carbon components. Sample 22 was obtained from PEEK as the starting material, i.e., pyrolyzable carbon component and Comparative Sample 7 was obtained from PVDC as the starting material. Sample 22 was activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours. Comparative Sample 7 was not activated using this method. The density of each sample was measured. The results are shown in Table 6. Phosphine (PH3) sorption isotherms were obtained by locating each sample in a separate gas storage vessel and charging each gas storage vessel with phosphine gas at a temperature of 21° C. and measuring the sorption capacity of each sample over a pressure range of 0 Torr to 760 Torr. The results are shown in FIG. 14. The amount of phosphine gas sorbed by each sample was measured by locating each sample in a separate gas storage vessel and charging to capacity each gas storage vessel with phosphine gas at 21° C. and 650 Torr. The results are shown in Table 6 as the phosphine sorption capacity. The amount of phosphine gas delivered from the gas storage vessel was measured by adjusting the pressure of the gas storage vessel from 650 Torr to 10 Torr and measuring the amount of phosphine gas delivered at 21° C. over the pressure range. The results are shown in Table 6 as the phosphine deliverable capacity. Additionally, Table 6 shows the percentage of sorbed phosphine gas that was desorbed as a ratio of the phosphine deliverable capacity to the phosphine sorption capacity. The amounts of phosphine gas delivered over the entire pressure range for Comparative Sample 7 and Sample 22 are shown in FIG. 15.

TABLE 6

| | | Phosphine | Phosphine | % of sorbed |
|---|---|---|---|---|
| | | Sorption | Deliverable | phosphine gas |
| | Density | Capacity | Capacity | that was |
| Sample | (g/cc) | (g/L) | (g/L) | desorbed |
| Comparative | 1.10 | 196 | 149.6 | 76% |
| Sample 7 | | | | |
| Sample 22 | 0.89 | 205.6 | 178 | 87% |

As shown in Table 6, as the density decreases, the deliverable capacity (from 650 Torr to 10 Torr) increases.

### Example 9

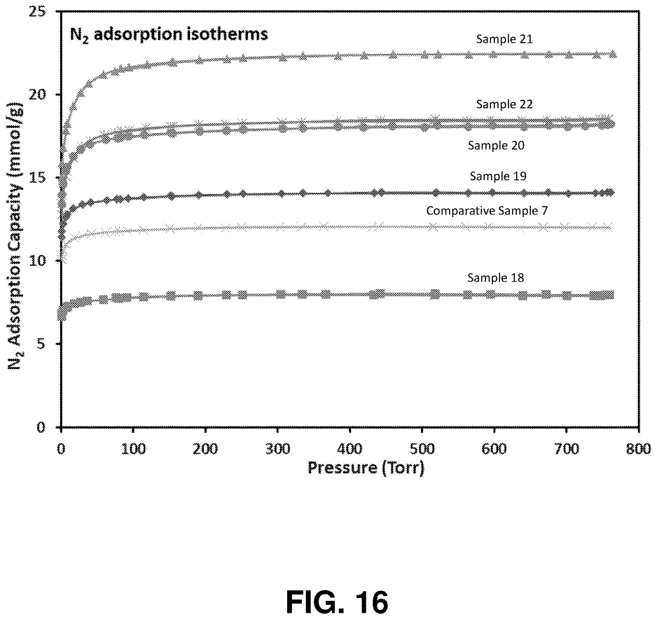

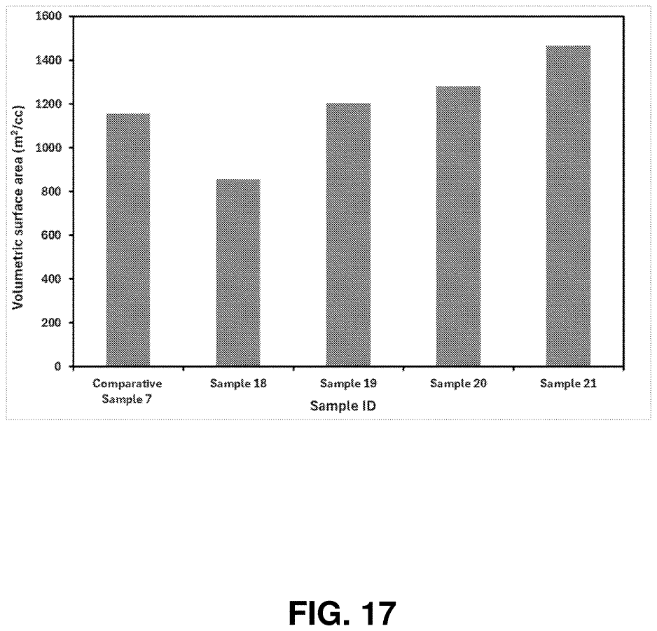

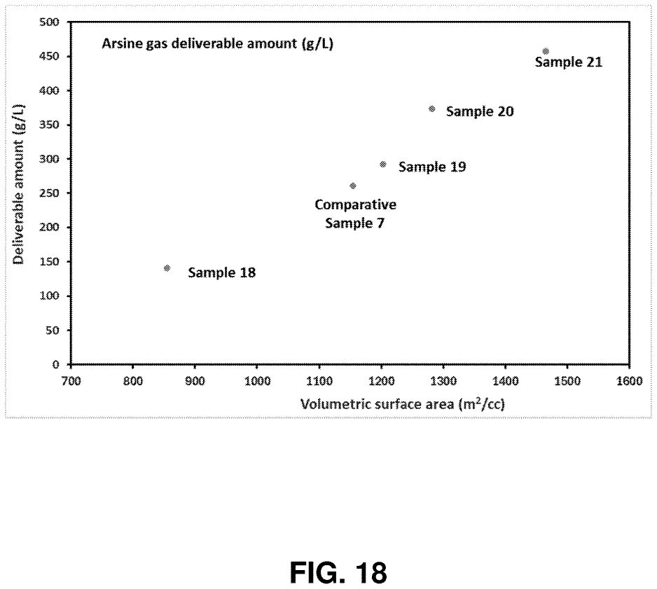

Nitrogen (N₂) sorption isotherms at 77 K were obtained by locating each sample in a separate gas storage vessel and charging each gas storage vessel with arsine gas at a temperature of 21° C. and measuring the sorption capacity of each sample over a pressure range of 0 Torr to 760 Torr. The results are shown in FIG. 16. The BET volumetric surface area of each sample was determined from the N₂ sorption isotherms. The results are shown in FIG. 17. As shown in FIGS. 16 and 17, the BET volumetric surface areas obtained from PEEK as a starting material (Sample 18-22) can be tailored. FIG. 18 shows the arsine deliverable amount versus the BET volumetric surface area of each sample. As shown in FIG. 18, as the BET volumetric surface area increases, the arsine deliverable amount increases.

### ASPECTS

Various Aspects are described below. It is to be understood that any one or more of the features recited in the following Aspect(s) can be combined with any one or more other Aspect(s).

Aspect 1 is an assembly comprising a gas storage vessel and a sorbent material contained in an interior volume of the gas storage vessel, wherein the sorbent material comprises an activated pyrolyzed carbon component, wherein, at a temperature of 21° C. and a pressure of 650 Torr or less, the activated pyrolyzed carbon component is configured to desorb at least 60% of a sorbed gas, as determined by a ratio of a gas deliverable capacity to a gas sorption capacity.

Aspect 2 is the assembly according to Aspect 1, wherein, at a temperature of 21° C. and a pressure of 650 Torr or less, the activated pyrolyzed carbon component is configured to desorb 60% to 100% of a sorbed gas, as determined by a ratio of a gas deliverable capacity to a gas sorption capacity.

Aspect 3 is the assembly according to any one of Aspects 1-2, wherein the sorbed gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

Aspect 4 is the assembly according to any one of Aspects 1-3, wherein the activated pyrolyzed carbon component has a density of 0.75 g/cm³ to 2.5 g/cm³.

Aspect 5 is the assembly according to any one of Aspects 1-4, wherein the activated pyrolyzed carbon component has a BET volumetric surface area of 1200 m²/cc to 1600 m²/cc.

Aspect 6 is the assembly according to any one of Aspects 1-5, wherein the activated pyrolyzed carbon component has a pore size distribution of 0.7 nm to 2.5 nm.

Aspect 7 is the assembly according to any one of Aspects 1-6, wherein the activated pyrolyzed carbon component comprises at least one of a polyvinylidene chloride (PVDC), a polyvinylidene fluoride (PVDF), a polytetrafluoroethylene (PTFE), a poly (ethene-co-tetrafluoroethene), or any combination thereof.

Aspect 8 is the assembly according to any one of Aspects 1-7, wherein the sorbent material comprises a monolithic activated pyrolyzed carbon component having at least one dimension in a range of 1 mm to 200 mm.

Aspect 9 is the assembly according to any one of Aspects 1-8, wherein, at a temperature of 21° C. and a pressure of 650 Torr or less, the activated pyrolyzed carbon component is configured to have a gas deliverable capacity of 150 g/L to 650 g/L.

Aspect 10 is a sorbent material comprising an activated pyrolyzed carbon component, wherein, when contained in a gas storage vessel, the activated pyrolyzed carbon component is configured to sorb and desorb a gas, wherein, at a temperature of 21° C. and a pressure of 650 Torr or less, the activated pyrolyzed carbon component is configured to desorb at least 60% of a sorbed gas, as determined by a ratio of a gas deliverable capacity to a gas sorption capacity.

Aspect 11 is the sorbent material according to Aspect 10, wherein, at a temperature of 21° C. and a pressure of 650 Torr or less, the activated pyrolyzed carbon component is configured to desorb 60% to 100% of a sorbed gas, as determined by a ratio of a gas deliverable capacity to a gas sorption capacity.

Aspect 12 is the sorbent material according to any one of Aspects 10-11, wherein the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

Aspect 13 is the sorbent material according to any one of Aspects 10-12, wherein the activated pyrolyzed carbon component has a density of 0.75 g/cm³ to 1.2 g/cm³.

Aspect 14 is the sorbent material according to any one of Aspects 10-13, wherein the activated pyrolyzed carbon component has a BET volumetric surface area of 1200 m²/cc to 1600 m²/cc.

Aspect 15 is the sorbent material according to any one of Aspects 10-14, wherein the activated pyrolyzed carbon component has a pore size distribution of 0.7 nm to 2.5 nm.

Aspect 16 is the sorbent material according to any one of Aspects 10-15, wherein the activated pyrolyzed carbon component comprises at least one of a polyvinylidene chloride (PVDC), a polyvinylidene fluoride (PVDF), a polytetrafluoroethylene (PTFE), a poly (ethene-co-tetrafluoroethene), or any combination thereof.

Aspect 17 is the sorbent material according to any one of Aspects 10-16, wherein the sorbent material comprises a monolithic activated pyrolyzed carbon component having at least one dimension in a range of 1 mm to 200 mm.

Aspect 18 is a method comprising adjusting at least one of a pressure, a temperature, or any combination thereof, of a gas storage vessel, wherein the gas storage vessel comprises an activated pyrolyzed carbon component and at least one sorbed gas on the activated pyrolyzed carbon component, and desorbing at least 60% of the at least one sorbed gas from the activated pyrolyzed carbon component.

Aspect 19 is the method according to Aspect 18, wherein the pressure is a pressure of 3 Torr to 650 Torr.

Aspect 20 is the method according to any one of Aspects 18-19, further comprising flowing the desorbed gas from the gas storage vessel to a process tool.

Aspect 21 is an assembly comprising a gas storage vessel and a sorbent material contained in an interior volume of the gas storage vessel, wherein the sorbent material comprises an activated pyrolyzed carbon component, wherein, when a pyrolyzed carbon component is activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours, to obtain the activated pyrolyzed carbon component, the activated pyrolyzed carbon component has a gas deliverable capacity that is at least 10% greater than a gas deliverable capacity of an unactivated pyrolyzed carbon component or a differently activated pyrolyzed carbon component.

Aspect 22 is an assembly comprising a gas storage vessel and a sorbent material contained in an interior volume of the gas storage vessel, wherein the sorbent material comprises an activated pyrolyzed carbon component, wherein, when a pyrolyzed carbon component is activated using an activating gas at a flow rate of 500 to 6000 cc/min, at a temperature of 500° C. to 1000° C., for a duration of 10 hours to 200 hours and then heat treated at a temperature of 500° C. to 1200° C. for a duration of 1 hour to 100 hours, to obtain the activated pyrolyzed carbon component, the activated pyrolyzed carbon component has a BET volumetric surface area that is at least 10% greater than a BET volumetric surface area of an unactivated pyrolyzed carbon component or a differently activated pyrolyzed carbon component.

Aspect 23 is a sorbent material comprising an activated pyrolyzed carbon component, wherein the activated pyrolyzed carbon component has characteristics defined by the following process steps: activating a pyrolyzed carbon component by using an activating gas at a flow rate of 500 to 6000 cc/min and at a temperature of 500° C. to 1000° C. for a duration of 10 hours to 200 hours, and heat treating the pyrolyzed carbon component at a temperature of 500° C. to 1200° C. for a duration of 1 hour to 100 hours.

Aspect 24 is a method comprising obtaining a pyrolyzable component, wherein the pyrolyzable component comprises at least one of a polyether ether ketone (PEEK), a polyether ketone ketone (PEKK), a polyphenylene oxide (PPO), or any combination thereof, oxidizing the pyrolyzable component, pyrolyzing the pyrolyzable component to form a monolithic pyrolyzed carbon component, and activating the monolithic pyrolyzed carbon component to obtain an activated monolithic pyrolyzed carbon component, wherein, when contained in a gas storage vessel, the activated monolithic pyrolyzed carbon component is configured to sorb and desorb a gas, wherein, at a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity.

Aspect 25 is the method according to Aspect 24, wherein the oxidizing comprises oxidizing at a temperature of 100° C. to 500° C.

Aspect 26 is the method according to any one of Aspects 24-25, wherein the oxidizing comprises oxidizing using an oxidizing gas at a flow rate of 500 cc/min to 6000 cc/min.

Aspect 27 is the method according to any one of Aspects 24-26, wherein the oxidizing comprises oxidizing such that the pyrolyzable component has a burn-off of up to 50%.

Aspect 28 is the method according to any one of Aspects 24-27, wherein the activating comprises activating the monolithic pyrolyzed carbon component by using an activating gas at a flow rate of 500 cc/min to 6000 cc/min and at a temperature of 500° C. to 1000° C.

Aspect 29 is the method according to any one of Aspects 24-28, wherein the activating comprises heating the monolithic pyrolyzed carbon component at a temperature of 500° C. to 1200° C.

Aspect 30 is the method according to any one of Aspects 24-29, wherein, at a temperature of 21° C. and a pressure of 650 Torr or less, the activated monolithic pyrolyzed carbon component is configured to desorb 60% to 100% of a sorbed gas, as determined by a ratio of a gas deliverable capacity to a gas sorption capacity.

Aspect 31 is the method according to any one of Aspects 24-30, wherein the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

Aspect 32 is the method according to any one of Aspects 24-31, wherein the activated monolithic pyrolyzed carbon component has a density of 0.75 g/cm³ to 1.2 g/cm³.

Aspect 33 is the method according to any one of Aspects 24-32, wherein the activated monolithic pyrolyzed carbon component has a pore size distribution of 0.7 nm to 2.5 nm.

Aspect 34 is the method according to any one of Aspects 24-33, wherein the activated monolithic pyrolyzed carbon component has a BET volumetric surface area of 1200 m²/cc to 1600 m²/cc.

Aspect 35 is the method according to any one of Aspects 24-34, wherein the activated monolithic pyrolyzed carbon component has at least one dimension in a range of 1 mm to 200 mm.

Aspect 36 is the method according to any one of Aspects 24-35, wherein, at a temperature of 21° C. and a pressure of 650 Torr or less, the activated monolithic pyrolyzed carbon component is configured to have a gas deliverable capacity of 150 g/L to 650 g/L.

Aspect 37 is a sorbent material comprising an activated monolithic pyrolyzed carbon component, wherein, when contained in a gas storage vessel, the activated monolithic pyrolyzed carbon component is configured to sorb and desorb a gas, wherein, at a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity.

Aspect 38 is the sorbent material according to Aspect 37, wherein the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

Aspect 39 is the sorbent material according to any one of Aspects 37-38, wherein the activated monolithic pyrolyzed carbon component has a BET volumetric surface area of 1200 m²/cc to 1600 m²/cc.

Aspect 40 is the sorbent material according to any one of Aspects 37-39, wherein the activated monolithic pyrolyzed carbon component has a density of 0.8 g/cm³ to 1.2 g/cm³.

Aspect 41 is an assembly comprising a gas storage vessel and a sorbent material contained in an interior volume of the gas storage vessel, wherein the sorbent material comprises an activated monolithic pyrolyzed carbon component, wherein, at a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity.

Aspect 42 is the assembly according to Aspect 41, wherein, at a temperature of 21° C. and a pressure of 650 Torr or less, the activated monolithic pyrolyzed carbon component is configured to desorb 60% to 100% of a sorbed gas, as determined by a ratio of a gas deliverable capacity to a gas sorption capacity.

Aspect 43 is the assembly according to any one of Aspects 41-42, wherein the activated monolithic pyrolyzed carbon component has a BET volumetric surface area of 1200 m²/cc to 1600 m²/cc.

While the present disclosure has been described with reference to one or more particular embodiments, those skilled in the art will recognize that many changes may be made thereto without departing from the spirit and scope of the present disclosure. Each of these embodiments and obvious variations thereof is contemplated as falling within the spirit and scope of the present disclosure. It is also contemplated that additional embodiments according to aspects of the present disclosure may combine any number of features from any of the embodiments described herein. Accordingly, the scope of the present disclosure should not be limited by the particular embodiments described herein, but should be defined only by the claims that follow.

What is claimed is:

1. A method comprising:
obtaining a pyrolyzable component,
wherein the pyrolyzable component comprises at least one of a polyether ether ketone (PEEK), a polyether ketone ketone (PEKK), a polyphenylene oxide (PPO), or any combination thereof;
oxidizing the pyrolyzable component;
pyrolyzing the pyrolyzable component to form a monolithic pyrolyzed carbon component; and
activating the monolithic pyrolyzed carbon component to obtain an activated monolithic pyrolyzed carbon component,
wherein, when contained in a gas storage vessel, the activated monolithic pyrolyzed carbon component is configured to sorb and desorb a gas,
wherein, at a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity.

2. The method of claim 1, wherein the oxidizing comprises oxidizing at a temperature of 100° C. to 500° C.

3. The method of claim 1, wherein the oxidizing comprises oxidizing using an oxidizing gas at a flow rate of 500 cc/min to 6000 cc/min.

4. The method of claim 1, wherein the oxidizing comprises oxidizing such that the pyrolyzable component has a burn-off of up to 50%.

5. The method of claim 1, wherein the activating comprises activating the monolithic pyrolyzed carbon component by using an activating gas at a flow rate of 500 cc/min to 6000 cc/min and at a temperature of 500° C. to 1000° C.

6. The method of claim 1, wherein the activating comprises heating the monolithic pyrolyzed carbon component at a temperature of 500° C. to 1200° C.

7. The method of claim 1, wherein, at a temperature of 21° C. and a pressure of 650 Torr or less, the activated monolithic pyrolyzed carbon component is configured to desorb 60% to 100% of a sorbed gas, as determined by a ratio of a gas deliverable capacity to a gas sorption capacity.

8. The method of claim 1, wherein the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydrides, a halide compound, an organometallic compound, or any combination thereof.

9. The method of claim 1, wherein the activated monolithic pyrolyzed carbon component has a density of 0.75 g/cm³ to 1.2 g/cm³.

10. The method of claim 1, wherein the activated monolithic pyrolyzed carbon component has a pore size distribution of 0.7 nm to 2.5 nm.

11. The method of claim 1, wherein the activated monolithic pyrolyzed carbon component has a BET volumetric surface area of 1200 m²/cc to 1600 m²/cc.

12. The method of claim 1, wherein the activated monolithic pyrolyzed carbon component has at least one dimension in a range of 1 mm to 200 mm.

13. The method of claim 1, wherein, at a temperature of 21° C. and a pressure of 650 Torr or less, the activated monolithic pyrolyzed carbon component is configured to have a gas deliverable capacity of 150 g/L to 650 g/L.

14. A sorbent material comprising:
an activated monolithic pyrolyzed carbon component,
wherein, when contained in a gas storage vessel, the activated monolithic pyrolyzed carbon component is configured to sorb and desorb a gas,
wherein, at a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity.

15. The sorbent material of claim 14, wherein the gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorous pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydrides, a halide compound, an organometallic compound, or any combination thereof.

16. The sorbent material of claim 14, wherein the activated monolithic pyrolyzed carbon component has a BET volumetric surface area of 1200 m²/cc to 1600 m²/cc.

17. The sorbent material of claim 14, wherein the activated monolithic pyrolyzed carbon component has a density of 0.75 g/cm³ to 1.2 g/cm³.

18. An assembly comprising:
a gas storage vessel; and
a sorbent material contained in an interior volume of the gas storage vessel,
wherein the sorbent material comprises an activated monolithic pyrolyzed carbon component,
wherein, at a temperature of 21° C. and a pressure of 650 Torr or less, the activated monolithic pyrolyzed carbon component is configured to desorb at least 60% of a sorbed gas, as determined by a ratio of a gas deliverable capacity to a gas sorption capacity.

19. The assembly of claim 18, wherein, at a temperature of 21° C. and a pressure of 650 Torr or less, the activated monolithic pyrolyzed carbon component is configured to desorb 60% to 100% of a sorbed gas, as determined by a ratio of a gas deliverable capacity to a gas sorption capacity.

20. The assembly of claim 18, wherein the activated monolithic pyrolyzed carbon component has a volumetric surface area of 1200 m²/cc to 1600 m²/cc.
